(19) United States
(12) Patent Application Publication
(10) Pub. No.: US 2005/0070320 A1
(43) Pub. Date: Mar. 31, 2005

(54) Method and apparatus to reduce dispatch delays in dispatch communication networks

(76) Inventor: Paul W. Dent, Pittsboro, NC (US)

Correspondence Address: COATS & BENNETT, PLLC, P O BOX 5, RALEIGH, NC, 27602, US

(21) Appl. No.: 10/672,531

(22) Filed: Sep. 26, 2003

(51) Int. Cl. H04Q 7/20

(52) U.S. Cl. 455/516; 455/515; 455/519

(57) ABSTRACT

A communication network supports push-to-talk communications with reduced dispatching delays by eliminating channel grant/request handshaking on the uplink and the downlink. A pool of communication channels can be associated with a group of nets that include one or more mobile terminals. Any terminal can send dispatch traffic immediately on an assigned uplink channel simply by seizing the channel. The network detects such traffic and retransmits it on a downlink channel monitored by the group of nets. Along with the retransmitted traffic, the network sends a net ID and a new downlink channel assignment. Terminals in the targeted net process the retransmitted traffic and non-targeted terminals switch to the new channel. Alternatively, the control channel can be multiplexed to signal traffic channel assignments as needed for all nets, and traffic can be transmitted on the indicated channels for reception by targeted terminals. The reduced delays particularly benefit networks incorporating satellite relays.

### BACKGROUND OF THE INVENTION

The present invention generally relates to push-to-talk communications and particularly relates to reducing dispatching delays in such communications.

Several types of two-way radio systems enjoy present-day use. An early two-way radio technology, such as used in Citizens' Band (CB), amateur (Ham) radio, and some military tactical radio nets, designates a frequency or channel to be used exclusively by a group of stations forming a “net.” In CB and Ham radio, such nets are established ad hoc, whereas the channel frequencies are specifically assigned to designated nets in professional and military usage.

Landmobile radio systems as used by police and emergency services are characterized by a demand for a large number of channels of low duty factor. This has led to the development of a second type of two-way radio systems, in which nets are not assigned to dedicated channels, but rather share a pool of channels on a demand assignment basis. The number of nets that can share a channel pool is greater than the number of channels to an extent that depends on an average net activity factor, thus achieving “trunking gain.”

A conventional trunked two-way radio system broadcasts a control channel to which all communication devices or stations listen while idle. When a communication is initiated by one of the devices, some form of a channel request message is transmitted on the uplink control channel of the nearest network base station and the network assigns one of the pooled channels and communicates the assigned channel to the requesting device and to the other devices in the same net. The network typically provides this information in a channel grant message.

Another type of two-way radio system uses cellular radio as its basis. The typical delays associated with conventional cellular telephone dialing times and call setup/connection times would cause intolerable push-to-talk dispatching delays. Thus, conventional cellular systems that support push-to-talk communications include a special, fast call set-up procedure that allow a cellular radio device to quickly request and be granted a traffic channel for transmitting dispatch traffic to a pre-designated group of other devices. The reduced delay call request/grant procedure is triggered responsive to a push-to-talk event—e.g., button press—at the device. Such operation is referred to as providing “dispatch over cellular” and stands as a selling point of certain cellular services, such as those provided in the United States by NEXTEL for example.

### SUMMARY OF THE INVENTION

The present invention comprises a method and apparatus to reduce dispatching delays in push-to-talk communication networks that can include one or more orbiting satellite relay stations. Broadly, the present invention provides random access detection for originating mobile terminals belonging to one or more radio nets such that they can send dispatch traffic targeted to other mobile terminals in their corresponding radio nets to the network on one or more assigned uplink channels without need for explicit channel request/grant negotiation. The ability to send dispatch traffic without channel negotiation eliminates one component of dispatch delay in a trunked radio system configured according to the present invention. Further, the present invention provides for substantially immediate retransmission of received dispatch traffic to the targeted radio net, and may provide a resource controller to manage pools of channel resources used for carrying dispatch traffic to and from pluralities of radio nets, and the controller may change or update which radio nets are allocated to which channels or pools of channels based on, for example, the relative duty factors of the individual radio nets.

In an exemplary embodiment, mobile terminals in one or more radio nets share a downlink channel selected from a pool of channel resources at the network. One or more uplink channels are associated with each shared downlink channel and the network retransmits dispatch traffic received from an originating mobile terminal on any of those one or more uplink channels is retransmitted on the shared downlink channel. The network also transmits an indicator of the originating mobile terminal's radio net identity so that mobile terminals in the same net can recognize that the retransmitted dispatch traffic on the shared downlink channel is targeted to them. Further, the network may transmit a new shared downlink channel assignment on the shared downlink channel so that mobile terminals not in the targeted net can move to the new shared downlink channel, which also may be selected from the pool of channel resources. By associating any channel reallocation delays to the inactive (non-targeted) radio nets rather than to the active radio net targeted by the originating mobile station, the present invention eliminates another component of dispatch delay. Note that the network also may transmit end-of-message indicators to indicate the end of dispatch traffic and may repeat its transmission of new shared downlink channel assignments so that mobile terminals in the targeted net move to a new shared downlink channel after the originating mobile terminal finishes its transmission of dispatch traffic.

In another exemplary embodiment, mobile terminals in one or more radio nets share a multiplexed downlink channel that may be divided into a plurality of sub-channels, e.g., timeslots, such that each radio net sharing the channel is allocated to one or more of the sub-channels. In response to receiving dispatch traffic from an originating mobile terminal, the network transmits an indication of such receipt on the sub-channel(s) corresponding to the radio net targeted by the originating mobile terminal. The indication may comprise or include a downlink traffic channel assignment that identifies the downlink traffic channel(s) that are or will be used by the network to retransmit the dispatch traffic. Thus, the sub-channel(s) allocated to the targeted radio net are used to apprise mobile terminals in the targeted net of which downlink traffic channel or channels they should tune to for receipt of the retransmitted dispatch traffic.

### BRIEF DESCRIPTION OF THE DRAWINGS

FIG. 1 is a diagram of a wireless communication network supporting dispatch communications according to an exemplary embodiment of the present invention.

FIG. 2 is a logic flow diagram of an exemplary method of supporting dispatch communications.

FIG. 3 is a logic flow diagram of an exemplary method of retransmitting dispatch traffic.

FIG. 4 is a diagram of an exemplary communication signal format.

FIGS. 5A and 5B are logic flow diagrams of exemplary dispatch-related processing at a mobile terminal.

FIG. 6 is a logic flow diagram of another exemplary method of retransmitting dispatch traffic.

FIG. 7 is a diagram of an exemplary configuration for a multiplexed downlink control channel that can be used to support exemplary dispatching.

FIG. 8 is a diagram of exemplary channel-to-channel timing that can be used in relation to a multiplexed downlink control channel.

FIG. 9 is diagram of an exemplary retransmission delay (offset) method that can be used to decrease power consumption at a mobile terminal.

FIGS. 10A and 10B are diagrams of exemplary details for a communication network according to one or more exemplary embodiments of the present invention.

FIG. 11 is a diagram of a satellite-relay based embodiment of a communication network according to one or more exemplary embodiments of the present invention.

FIG. 12 is a diagram of an exemplary mobile terminal configured to support exemplary dispatch communication methods.

### DETAILED DESCRIPTION OF THE INVENTION

Certain broad ideas must be introduced before moving into detailed exemplary descriptions because the present invention may be implemented in a variety of radio networks according to a variety of communication types, e.g., CDMA, TDMA, etc. First, as used herein, the term “channel” describes a communication signal at any selected frequency, time, code, or any combination thereof. Examples of channels include, but are not limited to, an assigned CDMA spreading code on a selected carrier frequency, one or more assigned timeslots within repeating TDMA frames at one or more selected frequencies, a defined sequence of frequency hops, code hops, or a combination of frequency and code hops.

Further, in broad terms, an exemplary communication system according to the present invention comprises a network of radio base or relay stations in communication with a plurality of subscriber terminals (e.g., mobile terminals) and, optionally, in communication with other subscribers linked by other means such as landline to the network stations. The network station or stations broadcast a control channel signal to which the terminals synchronize when idle.

In an exemplary embodiment, an originating terminal immediately transmits dispatch traffic responsive to a push-to-talk event at the terminal using an uplink channel that is assigned to it and shared by other terminals in one or more radio nets. The network monitors the uplink channel to detect such transmissions, thereby allowing any terminal originating dispatch traffic to seize the uplink control channel without performing an explicit channel request. In this way, the delay normally involved in exchanging channel requests and grants (handshaking) in a trunked radio system using pooled channels is avoided.

The network substantially immediately retransmits the incoming dispatch traffic on downlink control channel being monitored by terminals in the same radio nets. Effectively, then, the downlink control channel is “stolen” for transmission of dispatch traffic to the targeted radio net. To enable the reception of subsequent dispatch traffic by terminals in the non-targeted nets, the network includes an indication of a new control channel assignment on the downlink control channel along with retransmitting the dispatch traffic. The non-targeted terminals can thus begin monitoring the new downlink control channel.

In a second broad embodiment of the present invention, whenever a greater number of potential communications user groups share a smaller number of channel resources an overhead control channel is provided on a downlink to the users, the control channel being multiplexed such that sub-channels of it are allocated to different radio nets. For example, the channel can be divided into sleep-mode slots, each sleep-mode slot being associated with one of the user groups, wherein data transmitted by the network in the sleep mode slots indicates to the associated user groups whether there is dispatch traffic being transmitted or to be transmitted for the group, and further to indicate which of the limited number of channel resources has been momentarily assigned to carry that traffic. According to this embodiment, an efficient dispatch or push-to-talk communications mode with reduced traffic dispatching delays may be implemented in a spread spectrum system using orthogonal codes or orthogonal frequency hopping.

Communication signals sent by the network can also contain an indication of the terminal, terminal group or net to which the communication is addressed. Thus, if two different communications attempt to grab the same uplink control channel simultaneously for transmission of dispatch traffic, an indication of the winner is included in the corresponding downlink transmission from the network station and the originating loser can immediately switch to a new uplink channel, if one is available, to continue its dispatching attempt. Further, the number of nets or terminals assigned to listen to the same control channel can be limited to ensure that contention is infrequent. For example, different control channels can be provided for different geographical areas and assigned to terminals or nets according to their locations. Moving terminals can be handled by mobility management techniques such as registration and handover, as is known from cellular radio communication systems.

Thus, in broad terms, in one embodiment, the present invention comprises a method of reducing dispatching delays in a push-to-talk radio network based on assigning a pool of downlink channels to be shared by a group of radio nets, monitoring one or more uplink channels associated with mobile terminals in the group of radio nets for dispatch traffic such that the mobile terminals can transmit dispatch traffic to the network on the one or more uplink channels without need for explicit channel grant/request procedures receiving dispatch traffic from an originating one of the mobile terminals, and retransmitting the dispatch traffic on one of the downlink channels that currently is selected as a downlink control channel for the group, along with transmitting an indication of radio net identity of the originating mobile terminal to enable other mobile terminals in the radio net of the originating mobile terminal to recognize the dispatch traffic as being targeted to them. The method may further comprise transmitting an indication of control channel reassignment on the selected downlink control channel along with retransmitting the dispatch traffic to enable mobile terminals not in the radio net of the originating mobile terminal to move to a newly selected downlink control channel as indicated by the indication of control channel reassignment.

In another exemplary embodiment, the present invention broadly comprises a method of reducing dispatching delays in a push-to-talk radio network, the method based on allocating a pool of channels to be shared by a plurality of radio nets, using one or more downlink channels in the pool as downlink control channels, associating one or more uplink channels with each downlink control channel and assigning one or more radio nets to each downlink control channel, monitoring the one or more uplink channels for dispatch traffic from mobile terminals assigned to the one or more uplink channels to thereby enable transmissions of dispatch traffic from the mobile terminals to the network without need for explicit channel/grant request procedures, receiving dispatch traffic from an originating mobile terminal in one of the radio nets assigned to the one or more uplink channels, and transmitting downlink traffic channel assignments on the associated downlink control channel for receipt by mobile terminals in the radio net of the originating mobile terminal and, substantially, at the same time, retransmitting the dispatch traffic from the originating mobile terminal on one or more downlink traffic channels corresponding to the downlink traffic channel assignments.

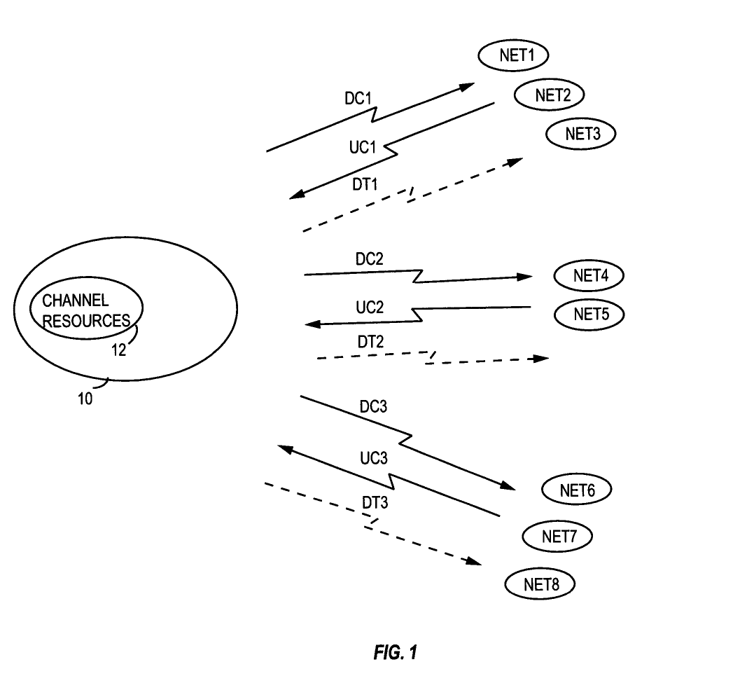

With the above framework in mind, FIG. 1 presents a simplified illustration of a wireless communication network 10 with certain available communication channel resources 12 (uplink and downlink). Network 10 supports push-to-talk communication between mobile terminals (not shown) in each of a plurality of radio nets, NET1, NET2, and so on. Each radio net can include essentially any number of mobile terminals. By way of example, network 10 assigns shared downlink and uplink control channels DC1 and UC1, respectively, to NETS 1, 2, and 3, assigns DC2 and UC2 to NETS 4 and 5, and assigns DC3 and UC3 to NETS 6, 7, and 8.

According to this method, any mobile terminal in NETS 1, 2, or 3 can seize UC1 for transmission of mobile-initiated dispatch traffic, which is detected by network receiver(s) in network 10. Likewise, any mobile terminal in any other net can seize its assigned uplink channel simply by beginning transmission of dispatch traffic. As used herein, dispatch traffic denotes push-to-talk traffic or other immediately transmitted traffic.

Responsive to detecting such incoming dispatch traffic, network 10 more or less immediately begins retransmitting the dispatch traffic on a downlink channel assigned to the targeted radio net. According to one exemplary embodiment, the downlink channel used for retransmission is the shared downlink channel already assigned to the targeted net (and to other nets sharing that channel). According to another embodiment, network 10 uses the shared downlink channel already assigned to the targeted net to send a downlink traffic channel assignment that indicates the traffic channel that is (or will be) carrying the retransmitted dispatch traffic. Mobile terminals in the targeted net can thus configure their radio receivers for reception on the assigned downlink traffic channel.

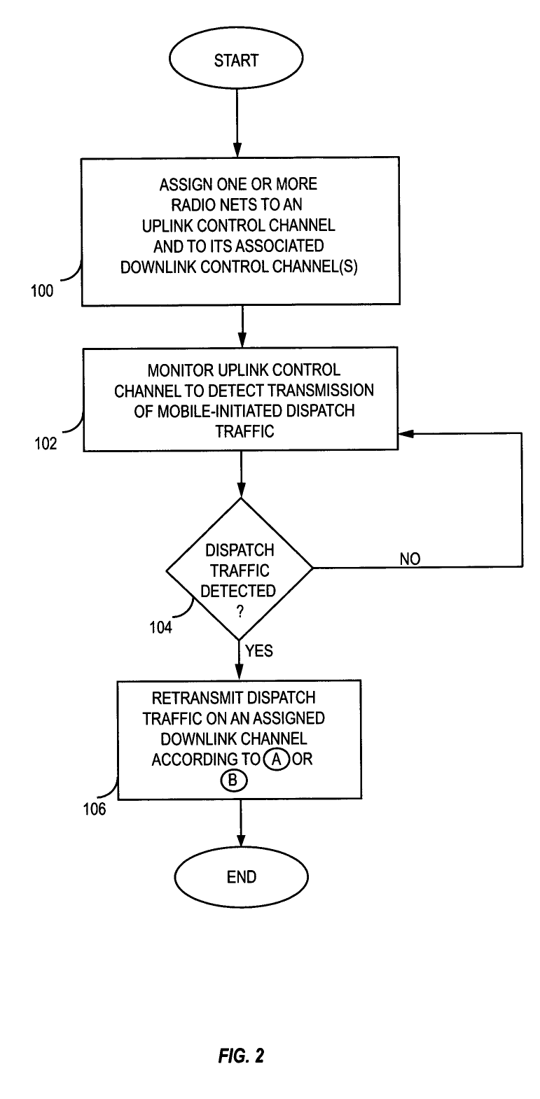

FIG. 2 illustrates exemplary processing logic for carrying out the above operations. Processing begins with assigning one or more nets to a shared uplink control channel and to one or more shared downlink control channels (Step 100). There may be one-to-one, one-to-many, or many-to-many relationships between uplink and downlink control channels, depending on, for example, whether mobile terminals in a given net are geographically disperse such that disparate network base stations are needed to support the terminals in a given net. Thus, the uplink control channels from several different service areas may be cross-associated with the downlink control channels in those (and other) areas so that a mobile terminal in one service area can dispatch to other mobile terminals in its net even if those other terminals reside in other service areas. A network manager may coordinate such channel linking and control based on tracking or otherwise being aware of the service locations of the mobile terminals.

In any case, processing continues with the network 10 monitoring a shared uplink control channel to detect incoming dispatch traffic from an originating mobile terminal in a net that currently is assigned to the uplink channel (Step 102). As detailed later herein, network 10 may include one or more random access detection receivers that permit it to detect incoming dispatch traffic without need for explicit handshaking, i.e., without need for first receiving a channel request message and or for responding with a channel grant message.

If dispatch traffic is detected on the uplink channel (Step 104), network 10 immediately retransmits the dispatch traffic to the targeted radio net (Step 106). Retransmission in a first embodiment (“A”) significantly reduces the overall delay from initial transmission from the originating mobile terminal to delivery to the other mobile terminals in the originating mobile terminal's radio net by an improved channel assignment protocol. According to an exemplary assignment protocol method, a channel is not assigned to a newly initiated communication—dispatch event—but rather to the control channel it steals.

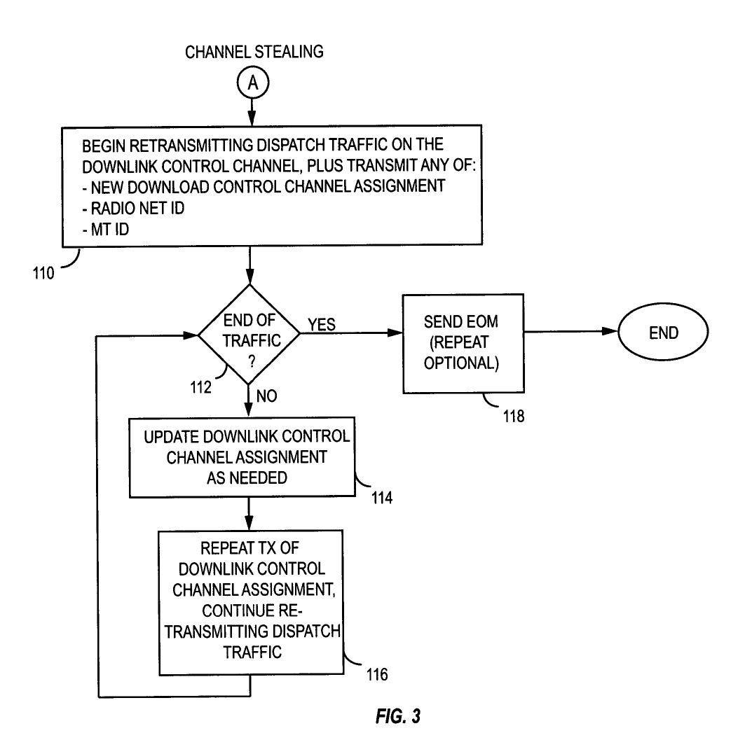

Thus, a communication is initiated by stealing an existing control channel immediately, and indicating to the other potential users to where the control channel has been relocated. This avoids the CHANNEL REQUEST, CHANNEL GRANT protocol delay of prior art methods of allocating a free channel to the traffic channel and leaving the control channel unchanged. In this way, traffic (such as voice) may accompany the very first signal transmitted from the transmitting mobile terminal to the network, without waiting for a free channel to be assigned. FIG. 3 illustrates an exemplary channel stealing protocol according to a first embodiment of the invention. The illustrated processing logic can be performed from Branch “A” of the process flow of FIG. 2.

For ease of discussion, assume that NETS 1, 2, 3, and 4 are assigned to a shared uplink control channel UC1, and to a shared downlink control channel DC1. Continuing with this scenario, assume that a mobile terminal in NET2 temporarily seizes UC1 by initiating the transmission of dispatch traffic responsive to a push-to-talk event, for example, and that network 10 has detected this incoming traffic as shown in FIG. 2.

First, one notes that allowing any mobile terminal in any assigned net to seize (steal) UC1 eliminates the need for channel negotiations in advance of transmitting dispatch traffic from the mobile terminals to the network 10. Second, one notes that beginning retransmission of the dispatch traffic by stealing DC1 reduces the dispatching delays essentially to the summation of signal transit times and whatever associated processing delays exist within network 10 and in the mobile terminals.

However, stealing DC1 to carry retransmitted dispatch traffic to mobile terminals in the targeted net without doing more would leave mobile terminals in the non-targeted nets without a usable downlink control channel on which they might receive retransmitted traffic. Therefore, network 10 can include additional information in or along with its retransmission of the dispatch traffic on DC1 (Step 110). For example, in an exemplary embodiment, network 10 transmits a radio net identity corresponding to the targeted net, a mobile terminal identity corresponding to the originating mobile terminal, and transmits a new downlink control channel assignment, i.e., a downlink control channel reassignment for the non-targeted radio nets. The data may be sent within the retransmitted dispatch traffic, such as by multiplexing or interleaving, as will be detailed later.

Sending the ID of the targeted radio net permits mobile terminals in the targeted net to recognize that the retransmitted dispatch traffic is intended for them and, conversely, permits mobile terminals not in the targeted net to determine that the traffic is not intended for them. Sending an identification for the originating mobile terminal may be useful if, for example, its identity is needed for secure decoding of the retransmitted dispatch traffic. Sending the mobile ID also is useful in that the originating mobile terminal also receives the retransmitted dispatch traffic, and it can definitively conclude that it has successfully seized the uplink control channel based on seeing its own ID in the retransmitted dispatch traffic. Mobile terminals not in the targeted net decode or otherwise process the new downlink channel assignment being transmitted on the stolen downlink control channel and “move” to the new shared downlink control channel.

Network 10 monitors for an end of dispatch traffic from the originating mobile terminal (Step 112). It can detect the end of transmission by timeout or by implicit or explicit signaling from the originating mobile terminal. Regardless, if the dispatch traffic has not ended, network 10 updates the downlink control channel reassignment information as needed (Step 114) and repeats its transmission of that information, along with continuing its retransmission of the continuing dispatch traffic (Step 116).

Repeating its transmission of the downlink channel reassignment accomplishes the two-fold purpose of providing late entry opportunities for mobile terminals in the non-targeted nets that might have missed the initial reassignment data for whatever reason. Thus, mobile terminals in the non-targeted nets are given repeated opportunities to receive the reassignment information. Further, once the dispatch traffic to the targeted net ends, the mobile terminals in that net should follow the non-targeted nets to the newly assigned downlink control channel, thereby preserving the grouping of nets.

On that point, it should be noted that the non-targeted nets might have been shifted one or more times after initially moving to the reassigned downlink control channel responsive to subsequent dispatching events. Thus, the network keeps its control channel reassignment information to reflect the currently assigned downlink control channel and transmits this information on all nets receiving retransmitted dispatch traffic on stolen control channels. Thus, as the dispatch traffic ends on those stolen channels, the mobile terminals in those targeted nets are automatically moved to the currently assigned downlink control channel.

More concretely, this example assumed that NETS 1, 2, 3, and 4 were assigned to shared downlink control channel DC1. An originating mobile terminal in NET2 seized UC1 and network 10 stole DC1 for retransmission of the dispatch traffic from the originating mobile terminal. Assuming that network 10 selected DC2 as the new downlink control channel for NETS 1-4, it would send reassignment information on DC1 identifying DC2 as the new downlink control channel and mobile terminals in NETS 1, 3, and 4 would begin monitoring DC2 while mobile terminals in NET2 received the dispatch traffic on DC1.

If DC2 was stolen before the dispatch retransmission completed on DC1, and the network 10 selected DC3 as the new downlink control channel, it would update the reassignment information on DC1 to indicate that the current downlink control channel was DC3 rather than DC2 and, likewise, it would transmit reassignment information on DC2 indicating that DC3 was the currently assigned downlink control channel.

Returning to the logic flow, once the dispatch traffic ends, network 10 transmits an end-of-message (EOM) indicator on the shared downlink channel. Although the present invention does not require this, the use of EOM indicators makes a more robust system because mobile terminals receiving retransmitted dispatch traffic do not falsely perceive signal fades, errors, or other interruptions as the end of the dispatch traffic. As with the channel reassignment information, network 10 may repeat its transmission of the EOM indicator one or more times to provide repeated opportunities for mobile terminals to receive. A mobile terminal in the targeted net moves to the reassigned downlink channel responsive to receiving the EOM indicator and thus rejoins the non-targeted nets.

Thus, one or more exemplary embodiments of the present invention anticipate that some mobile terminals will not receive important control information, such as traffic channel assignments or cipher initialization symbols, first time, and therefore includes appropriate “late entry” methods to give such mobile terminals later opportunities to receive the information at periodic intervals, thus ensuring that they do not completely miss out on important communications. It is usually a requirement that, if a dispatch-type radio is switched on while a communication is in progress, that it shall rapidly synchronize to and decode the communication. This means that necessary control information must be available continuously and not just at the beginning of a message. The present invention thus provides repeated opportunities at frequent intervals to receive the control channel reassignment indication so that radios that miss the first transmission of that data do not lose synchronization.

With regard to providing such information on the same channel that is stolen for retransmission of dispatch traffic to a targeted net, one way is to include the control channel assignment indication in an overhead symbol field in all transmitted traffic data bursts, slots or frames. It can also be advantageous in some implementations for control channel transmissions to include a description of the channel on which they are transmitted. This can be helpful when frequency-hopping channels are used, so that random reception of any frequency hop in a sequence can provide an indication of the correct sequence of frequencies to be followed. Alternatively, the control channel indication can be transmitted periodically in a predefined subset of traffic or control channel frames, such as every 13^{th} frame, which are used to carry periodic control information called the “Slow Associated Control Channel” or SACCH in cellular terminology. Of course, the control channel information can be updated as needed on all stolen channels to reflect the current control channel.

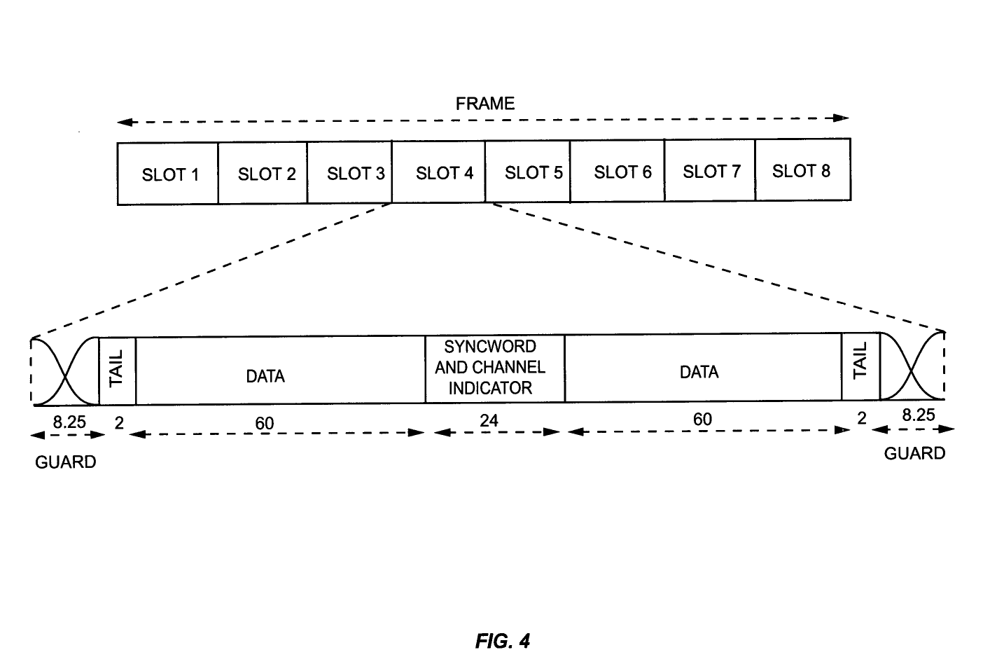

FIG. 4 shows a possible burst format for use in the present invention. Such bursts may be transmitted in one slot of a TDMA frame comprising several slots, e.g. 8 as illustrated in FIG. 4. Successive like-numbered slots also may be transmitted on different frequency channels, or selected successively from a set of allowed channels according to a frequency hopping algorithm.

An exemplary burst format comprises 8.25 modulation symbol periods of transmitter power up/down-ramping to avoid spectral splatter; 2 symbol periods of TAIL bits at the start and end, the purpose of which is to accommodate the impulse response length of the channel comprised of the transmit and receive filters as well as any multipath propagation; two data segments of 60 modulation symbols each, and a central syncword or midamble, placed so as to form a symmetrical burst format that can be processed equally in forward or reverse time order, after storing the received signal in memory, which is known in the art to be useful. The midamble is usually one of a fixed number of pre-agreed binary bit patterns, which may be analyzed at the receiver to establish a phase reference for coherent demodulation of the data symbols. According to one embodiment of the present invention, the syncword in the downlink control channel is a fixed pattern indicating the idle (non-stolen) state of the channel. Network 10 changes the pattern when it steals the channel for retransmission of dispatch traffic to one of the nets assigned to the downlink channel to indicate to where the control channel has been displaced, i.e., to indicate the downlink control channel reassignment for the non-targeted nets.

The pattern may also indicate to which net the traffic is addressed, and the identity of the originating transmitter within that net. Such information may be disguised, if desired, by continually altering the assignment of such patterns according to a random schedule under control of a secret key and a frame count.

Thus, a mobile terminal listening to the downlink control channel in idle mode analyzes the midamble assuming it to be the control channel (idle) pattern, determines therefrom a coherent reference with which to demodulate the data fields, and decodes the data fields to receive broadcast control information, such as the current frame count referred to above. Other control information can be a command addressed to a particular mobile terminal to move to a traffic channel to receive an individually addressed message or call of telephone type, in which case the control channel is not displaced to transmit that traffic.

When one of the mobile terminals initiates the transmission of dispatch traffic on the uplink control channel, it transmits that traffic with the midamble set to indicate its NET ID and individual ID. These may be shortened IDs, akin to what is known as the Temporary Mobile Terminal Identity or TMSI in cellular parlance, as it is only necessary to distinguish between the limited number of nets that are sharing the same control channel, and between the limited number of transceivers within that net. For example, 8 nets may share one control channel, and each net may contain a maximum number of 32 members. Thus, 3 bits would be needed to indicate the net and 5 bits would be needed to indicate the member.

These 8 bits would determine one of 256 predetermined 24-bit midambles that the originating mobile terminal would select, thus forming a 24,8 code that would have a high likelihood of first time right decoding at network 10. Once decoded, the pattern would be known and subsequent network station receptions would analyze the midamble only using the now known code to determine a coherent demodulation reference for demodulating the unknown data fields carried in the dispatch traffic communication.

In response to detecting a dispatch transmission, network 10, in an exemplary embodiment, decodes, re-encodes and relays the data fields from that dispatch on the corresponding downlink slots of the (stolen) downlink control channel. The midamble used on the stolen channel thus is changed to indicate that it is no longer serving as a control channel but rather as a downlink traffic channel for the targeted net. The mobile terminals in the targeted net may well also need to know the ID of the originating mobile terminal as this can be useful for ensuring that any encryption used possesses the necessary depth property, e.g. to allow the other mobile terminals in the net to decode the message using a key assigned specifically to the originating mobile terminal. Furthermore, as noted above, the midamble also can indicate to where the control channel has been displaced so that mobile terminals not in the targeted net can immediately switch to decoding the new control channel.

The number of bits needed to indicate the new control channel will be fewer than the number of bits needed to indicate the net ID, as the number of nets typically is greater than the number of pooled channels shared by them. Thus, to indicate one of 8 nets each with up to 32 members—mobile terminals, devices, etc.—sharing 8 pooled channels or less, a total of 11 bits must be encoded into the 24-bit midamble. This may be done efficiently using a 24, 11 polarity-independent Golay code for example, but other polarity independent codes may be used. Coding in this manner is optional but doing so ensures a high probability of first-time right decoding by a receiver. Even if first time right decoding is not achieved, such errors introduce only minor delays of one or more frame periods if two or three tries are required.

Successive midamble analyses may be non-coherently added to give successively increasing probability of decoding when a decoding failure is suspected due to the original control channel code appearing no longer the most likely and with no clear indication of the new midamble code. In any case, upon finally determining the midamble code, a mobile terminal determines if it is in the addressed (targeted) net, and if so it continues to receive and decode the traffic using the now established midamble code to determine its coherent reference. Otherwise, if it is not in the addressed net, it switches to listening to the new control channel as indicated in the midamble. Thus, a mobile terminal may at least partially analyze received dispatch traffic to determine whether the traffic is targeted to it, and then continue processing the data portions of the received traffic if so, or configure its receiver to listen to the new control channel if not.

Another exemplary method of associating a net ID with incoming dispatch traffic is based on coding. For example, with CDMA channels, the network 10 may assign terminator net-unique short codes to each radio set assigned to a given uplink control channel. When a mobile terminal transmits dispatch traffic to the network 10, its initial transmission may be encoded using the corresponding short code. This allows the network 10 to detect the ID of incoming dispatch traffic quickly and conveniently.

Further, the originating mobile terminal can switch from using the short ID code to using a mobile-specific long code once it sees that it has captured the uplink channel. In other words, if the originating mobile terminal detects its own ID in the retransmitted dispatch traffic, it can change from using the short code to the long code for the remainder of the current dispatch transmission. Doing so frees up the short code for use by other mobile terminals in the originating mobile terminal's net, and that allows the network to detect a subsequent (and potentially overlapping) uplink dispatch from any one of them.

In the above discussion, the network 10 “indicates” channels to the mobile terminals according to one or more exemplary methods. For example, indicating a channel, such as indicating a new control channel assignment, may mean indicating a timeslot, a frequency, or indicating a frequency hopping sequence selected within a number of pooled slots, frequencies or hop-sequences. Other parameters predefining a channel within a number of pooled channels could also be used, such as spreading codes.

A frequency hopping sequence can comprise hopping over a number of frequency channels greater than the number of pooled hop sequences. For example, given 100 frequency channels, 100 mutually orthogonal frequency hop sequences can be constructed and predefined as in U.S. Pat. No. 4,476,566 to Applicant, which is hereby incorporated by reference herein. However, only 5 of these sequences may be pooled to be shared by 8 nets, the other 95 being allocated to other pooled nets. Nevertheless, every net obtains the interference mitigation benefit of hopping over all 100 channels.

In general, the present invention provides great flexibility with regard to how communication channels are defined. In one or more exemplary embodiments, frequency hopping channels are used and a given control channel is described by a particular frequency hopping sequence. Communications signals carry in at least some of their frequency hops or bursts an indication of the sequence currently designated for the control channel, as well as an indication of the addresses for the communication. Such designations and indications may be enciphered to hinder eavesdropping or other unauthorized access to the system. In another embodiment, orthogonal direct sequence spread spectrum is used, and one orthogonal code, divided into sleep-mode timeslots, is used to indicate to the mobile terminals the codes assigned to traffic or broadcast control channels.

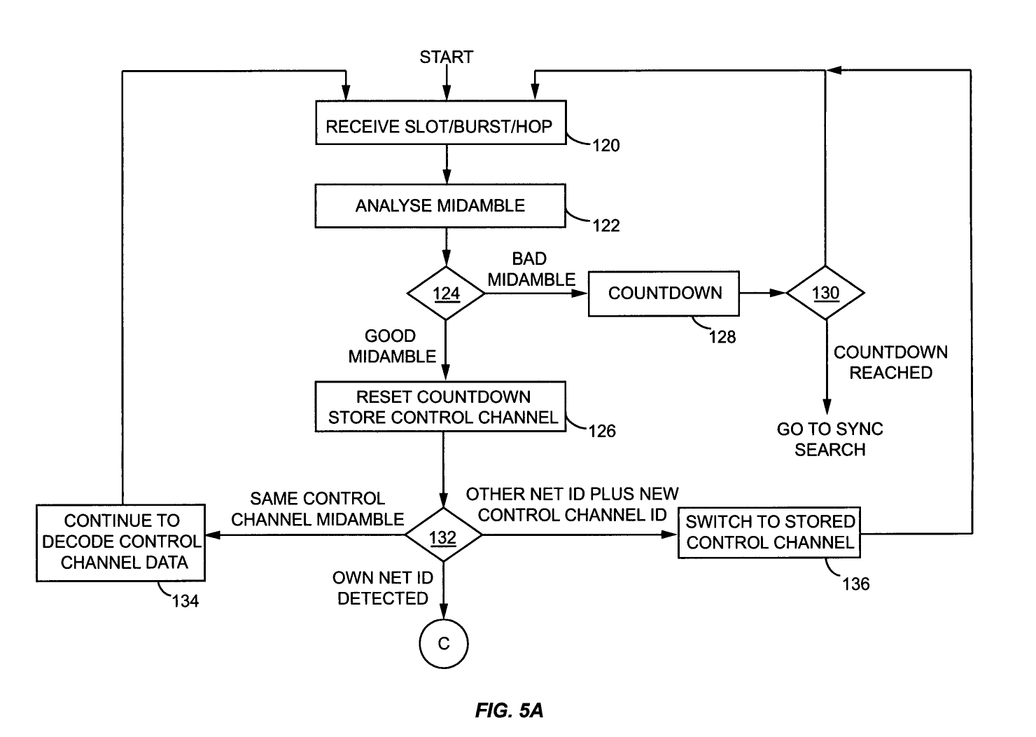

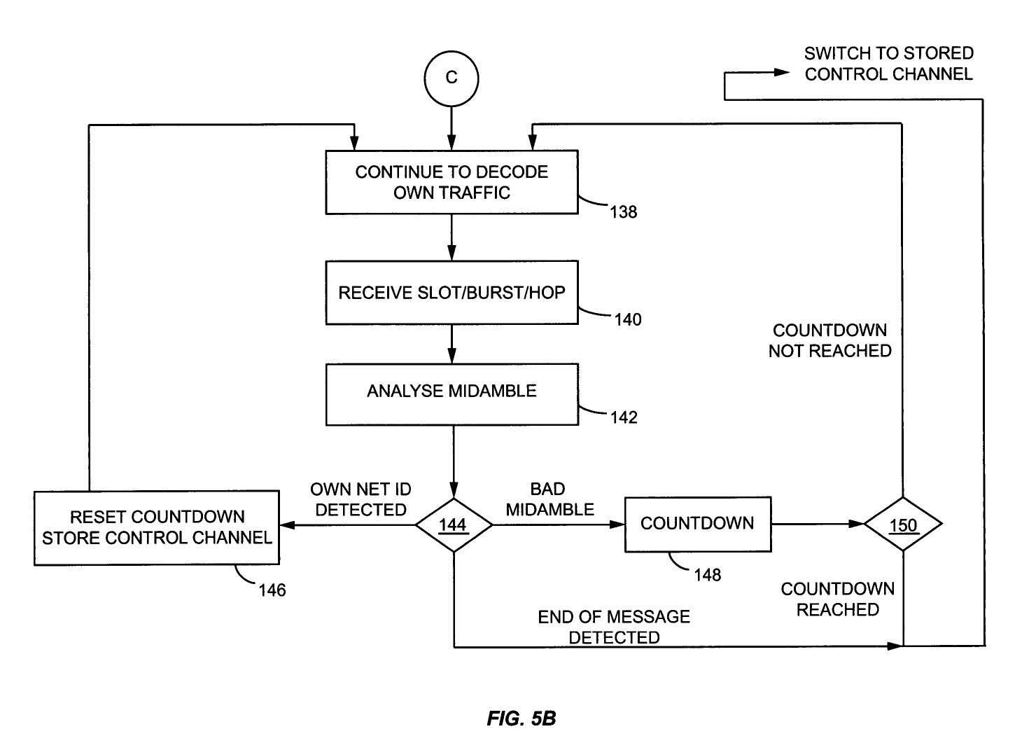

Turning to mobile terminal details, FIGS. 5A and 5B illustrate exemplary processing logic that may be used by mobile terminals for transitioning between standby (idle) and traffic reception states. After the mobile terminal is switched on, it executes a procedure (not shown) to find and synchronize to a valid signal. Processing thus begins (Step 120) with the mobile terminal receiving a signal segment such as a burst, slot or hop by amplifying, filtering, A to D converting, and storing signal samples in a memory. The signal samples are analyzed to determine what kind of midamble the signal segment contains (Step 122). A first decision is made as to whether the midamble is a distinct or good midamble, or an indistinct or bad midamble (Step 124). If the midamble is good, a countdown timer is reset and the control channel indicated in the good midamble is stored for future use (Step 126). If the midamble is bad, the countdown timer continues (Step 128) and, if expired (Step 130), the mobile terminal considers the channel lost and attempts to resynchronize with network 10.

Assuming a good midamble is received, it is determined if the midamble is a control channel midamble, and is the same control channel as may previously have been detected, or alternatively whether the midamble indicates that the control channel has been stolen and whether the traffic is intended for the mobile terminal's own net, or whether the midamble indicates that the signal is traffic intended for a different net (Step 132). If the midamble is the same (idle) control channel midamble, the mobile terminal continues to decode the received control channel data (Step 134) and then returns to Step 120 to receive the next signal segment.

If the midamble indicates that the control channel is not idle, i.e., it has been stolen for the retransmission of dispatch traffic not targeted to the mobile terminal's net, the mobile terminal switches to the new control channel corresponding to the reassignment ID detected (Step 130). The processing then returns to Step 120 to receive the next signal segment on the new control channel.

However, if the midamble is deemed to contain the mobile terminal's own net ID, it indicates that traffic intended for reception by it is in progress of being transmitted. Processing thus continues with the mobile terminal decoding the received traffic (Step 138), and on to receiving the next traffic signal segment (Step 140). After receiving the next signal segment, the midamble is again analyzed (Step 142).

If the midamble still contains the mobile terminal's net ID, the countdown timer is reset (Step 146) and the control channel indicated in the midamble is stored. Processing then returns to Step 138 to continue decoding retransmitted dispatch traffic. However, if the midamble is deemed bad, the countdown timer runs (Step 148) and it is checked whether a countdown value has been reached (Step 150). If not, processing returns with decoding the incoming traffic (Step 138) based on the assumption that it still is targeted to the mobile terminal's own net. If the countdown has been reached, however, processing continues with the mobile terminal switching to the control channel corresponding to the ID stored in Step 146. This allows the mobile terminal to time out of traffic reception responsive to receiving a certain number of bad midambles or receiving bad data over a certain time window.

Thus, if a bad midamble is detected, this may be temporary interference, so the mobile terminal times the reception problem while attempting to receive new signal segments in the hope that the temporary interference will subside. If, however, the countdown is reached without a valid midamble or EOM being detected, the mobile terminal switches to a previously stored control channel as being the most likely place it should look to receive a valid signal.

At the end of a traffic message, it can be advantageous to accelerate return to the idle mode, in order to flush a cipher machine for example, by sending a specific end-of-message (EOM) indicator, such as by changing the midamble back to a control channel indication for a predetermined number of successive signal segments. Upon detecting EOM (Step 144), the mobile terminal can then promptly return to idle mode via the processing at Step 136, which switches to the control channel indicated in the EOM.

In the above description and in FIGS. 5A and 5B, the term “analyze midamble” can include combining currently received signal samples with previously analyzed signal samples if such is useful to obtain a more distinct determination of the midamble when one instance alone is indistinct. A process of cumulative soft majority combining as disclosed in U.S. Pat. No. 5,568,513 to Applicant et al., may be used, for example, suitably adapted to the form of midamble coding used. For example, correlations with expected Golay or other codes can be non-coherently combined across successively received signal segments in order to improve the discrimination of the correct code from incorrect codes.

While the discussion immediately above referred in certain places to TDMA signal formats, those references are in no way limiting and it should be understood that the present invention can be useful in CDMA systems. In CDMA systems, radios in idle mode decode a control channel by despreading received signal samples with an assigned control channel spreading code.

In the event of traffic having to be passed, a message may be sent on the control channel informing a certain receiver or group of receivers of a spreading code assigned to the traffic. The receivers then despread the traffic with the indicated spreading code, but may continue to decode the control channel, as this is quite possible in CDMA systems where both signals may overlap. Indeed, the control channel may also serve as a coherent reference for decoding the traffic channel, as disclosed in U.S. Pat. No. 5,377,183 to Applicant, which is hereby incorporated by reference herein. The control channel can avoid the need of a coherent reference by use of a differential modulation, and the traffic channel data can be decoded in such a way that control channel errors do not cause traffic channel errors. Alternatively, an unmodulated pilot code can be provided as a coherent reference for both traffic channels and control channels.

An exemplary embodiment of the present invention avoids the delays associated with requesting and granting a code for carrying the dispatch traffic by stealing the control channel code to transmit the dispatch traffic. That stealing operation is directly analogous to the above described stealing of the control channel in the time domain. Network 10 can move the non-targeted mobile terminals to a new downlink control channel by including a frequently repeating overhead field in the stolen control channel indicating the new assignment.

A pilot symbol field interleaved with the data symbol field may be used, for example, to indicate the new control channel. The pilot symbol field is decoded as an unknown symbol field on the first occasion it changes upon grabbing the control channel for traffic, but thereafter may be treated as a known symbol field for the duration of the message. Since it repeats frequently, ample “late entry” opportunities are provided. The pilot symbol field in CDMA signal formats equates to the syncword in TDMA or frequency hopping signal formats, and could be used to carry the same types of side information as already discussed above, namely the new control channel indication, the originating mobile terminal's ID, and the ID of the targeted net.

While control channel stealing, whether in TDMA or CDMA networks, offers several advantages, including substantially reduced traffic dispatching delays, the present invention is not limited to such embodiments. In one or more exemplary embodiments, network 10 provides a multiplexed (common) downlink control channel having one or more radio nets assigned to it. In practice, a great many nets of sufficiently low activity—low duty factor—may be assigned to a multiplexed downlink control channel.

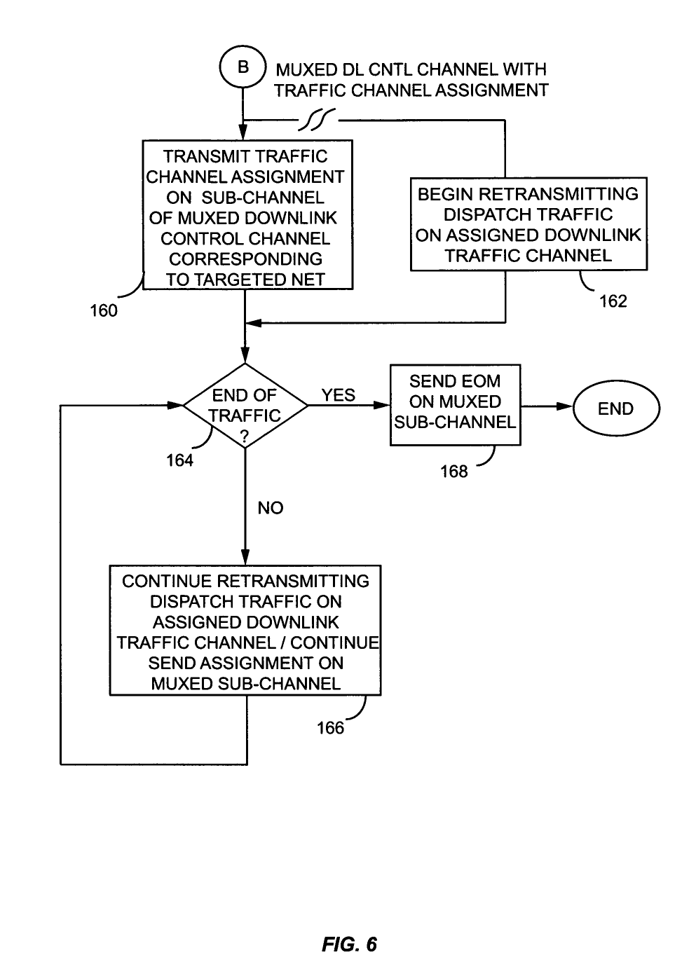

This was alluded to in FIG. 2, and FIG. 6 provides exemplary processing logic for Branch “B” in FIG. 2, wherein network 10 uses multiplexed downlink control channels. Processing for retransmission of the dispatch traffic incoming on an uplink control channel begins with network 10 transmitting an indication of the availability of that traffic on the sub-channel of the associated multiplexed downlink control channel (Step 160). Substantially at the same time, network 10 begins retransmitting the dispatch traffic on a downlink traffic channel selected by it from an available pool of channel resources (Step 162).

The indication of availability transmitted on the control channel itself can be an ID for the downlink traffic channel being used (or that will be used) for the retransmission of the dispatch traffic. With this approach, then, the control channel is not stolen, rather it is used in multiplex fashion to transmit downlink traffic channel assignments as needed to the various radio nets assigned to the channel.

Continuing with the processing flow, if the dispatch traffic had not ended (Step 164), network 10 continues retransmitting to the targeted net on the assigned downlink traffic channel and continues sending the traffic channel assignment information on the control channel to provide late entry opportunities to mobile terminals in the targeted net that might have missed previous transmissions of the traffic channel assignment for whatever reason (Step 166).

If network 10 detects an end of dispatch traffic for the targeted net (Step 164), it sends an EOM indicator on the targeted net's control channel sub-channel. Alternatively, network 10 sends an EOM on the downlink traffic channel assigned to the targeted net (Step 168).

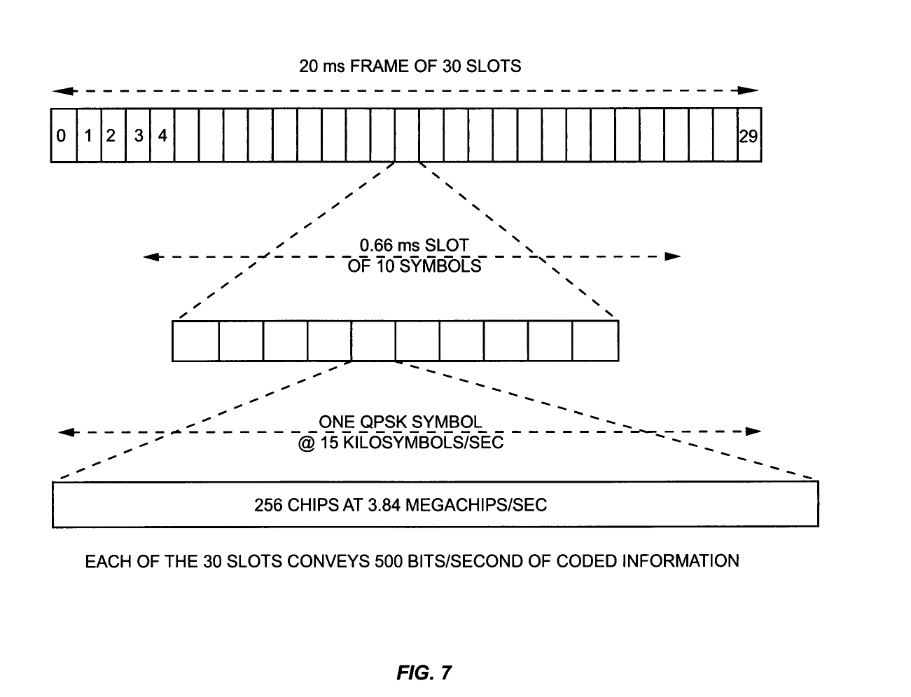

FIG. 7 illustrates an exemplary format that can be used by network 10 for configuring a multiplexed downlink control channel. The exemplary format comprises a TDMA frame/slot arrangement that is useful for both TDMA-based and CDMA-based communication signals. The illustrated downlink control channel is divided into a number of timeslots; thirty slots are illustrated to support individual control channel communication up to thirty different nets. That is, each radio net supported on the downlink by the control channel is assigned one or more specified timeslots to monitor. Each timeslot can be considered a separate sub-channel in the larger control channel that can be dedicated for signaling to a particular radio net.

In more detail, FIG. 7 illustrates exemplary chip, symbol, slot and frame structures derived from the 3G Wideband CDMA standard also known as UMTS. In the UMTS system, in common with other CDMA systems, the downlink uses orthogonal codes for different receivers, while the uplink uses non-orthogonal codes. The reason for using non-orthogonal codes on the uplink is that transmissions from different mobiles are too hard to synchronize to the fractional chip accuracy that is required to maintain orthogonality using conventional CDMA techniques. A form of CDMA that allows orthogonality to be maintained with reduced timing accuracy is disclosed in U.S. Pat. No. 6,215,762 to Applicant, and this may be used if it is desired to facilitate orthogonality on the uplink. The '762 patent is hereby incorporated by reference herein.

Whenever orthogonal codes are used, be it on the downlink or the uplink, a method of assigning a code to a communications user is required if the number of potential users is greater than the number of codes available.

Thus, the illustrated frame is 20 ms wide and is divided into 30 timeslots. The Wideband CDMA system UMPTS has 10 ms frames of 15 slots, but since most speech coders operate on 20 ms frames, it can be more convenient to consider a 20 ms frame of 30 slots. With that arrangement, each slot has a duration of ⅔rds of a millisecond and contains 2560 chips at a chiprate of 3.84 MHz. Different spreading factors can be used depending on the data rate. The illustration depicts a spreading rate of 256, meaning that 256 chips are used to represent one data symbol. A slot then contains 10 data symbols. Using QPSK for the underlying data symbols, 20 bits of data per slot are thereby conveyed. If all slots are used for the same data stream, the data rate is then 15 kilo symbols per second or 30 kilobits/second. Error correction coding is desirable to increase the tolerance to noise and interference, and a ½ error coding rate reduces the useful data rate to 15 kilobits/sec.

This is sufficient to accommodate a high quality voice coder running at 13 kilobits/sec plus some overhead for error detection codes such as a cyclic redundancy check code on each 20 ms frame of data. There is in principle enough margin also to accommodate a low bitrate, associated signaling channel, or other overhead bits such as dynamic power control bits. In low-delay terrestrial systems, power control bits are included frequently to achieve rapid dynamic power control; in a high delay satellite system however, this is fruitless and including a more error-protected power control code less frequently may be more logical. In designing such a system, trade-offs between modulation and coding should be made, for example, comparing the use of 8-psk symbols and rate ⅓^{rd} coding or 16 QAM and rate ¼ coding with QPSK and rate half coding. It frequently transpires that a communication system gains more from additional coding than it loses from the use of high modulation constellations.

Whenever coding is used, the use of interleaving should also be considered if the noise and interference environment is other than static, white, Gaussian noise. Other trade offs can comprise using a lower spreading rate, for example 128:1, but using only half the slots for one signal, i.e., 15 out of 30. This gives the same data rate. Another communications user can use the other half of the slots. Introducing such a TDMA element can have benefits for mobile terminals, such as eliminating the transmit receive duplexer where duplex telephone traffic is desired.

In general, then, an exemplary CDMA-based, embodiment, a communication network 10 comprises a communications system using orthogonal spread spectrum coding and providing reduced dispatching delays. Such a system thus may comprise an overhead control channel transmitted using a first orthogonal code, the overhead control channel being divided into timeslots, each timeslot being assigned to a given group of mobile terminals that form a radio net, a random access receiver to detect transmissions initiated by any originating one of the mobile terminals, and encoding and decoding circuits to decode the detected transmissions and re-encode them on a currently unassigned second orthogonal code, and to encode an indication of the second orthogonal code for transmission in the overhead control channel timeslot assigned to the radio net of the originating mobile terminal. In this embodiment, the network 10 may use an encoder to encode an identification of the originating mobile terminal that is transmitted in also is encoded by said encoder into the overhead control channel timeslot assigned to the radio net to which the originating mobile terminal belongs.

Decoding circuits in this embodiment may be configured to detect a specific End-of-Message (EOM) code and re-encode the EOM for retransmission in the overhead control channel timeslot one or more times before reverting the overhead control channel transmission to an idle pattern, and the originating mobile terminal may continue to transmit the EOM code until the re-encoded EOM is detected by the originating mobile terminal, whereupon the originating mobile terminal ceases transmission. As such, network 10 may be configured to continue transmission of the originating mobile terminal's re-encoded EOM on the corresponding downlink channel(s) until the it detects that the originating mobile terminal has ceased transmission.

Regardless, for greatest efficiency, coherent modulation and demodulation should be used, which means the receiver should be able to derive a phase reference signal from the received signal that has gone through the same channel as the data to be demodulated. Two methods of providing a phase reference are described in the UMTS standard: the first method employs some of the symbols in each slot as “pilot symbols” which are set to known values. The pilot symbol method provides a separate reference specific to each slot and therefore to each user, and this is useful when different user signals go through different channels. This may occur if per-user beamforming is used, for example.

An alternative exemplary method is to provide a common pilot code, which overlaps and is orthogonal to the traffic signal codes. This is efficient when all user signals and the pilot code traverse the same channel. In a satellite-based network 10, this means that the signals most likely are all in the same beam, and that per-user beamforming is not employed. The present invention contemplates operation in a satellite-based push-to-talk dispatching communication network 10 that can illuminate the entire earth or one or more entire service areas with a global pilot code beam that is received and can be used as a coherent reference for demodulating traffic signals transmitted in narrower beams, providing care is taken in determining the relative phasing of the global and individual beams.

It may be seen that a difference between CDMA and TDMA implementations is a potentially reduced underlying symbol rate, when symbols are transmitted in a continuous stream rather than compressed onto an allocated timeslot. There are, therefore, insufficient symbols in the 0.66 ms slot period of FIG. 7, when 256:1 spreading is used, to convey both traffic and the overhead information on control channel placement, net ID and originating mobile terminal ID. An exemplary solution is to dedicate all the symbols on a first code to this overhead information, designating that code to be a overhead channel, and designating a second code, indicated by the overhead channel, to be a broadcast control channel which may be stolen for traffic and displaced to a different code according to the principles outlined earlier herein.

One distinct advantage to the multiplexed control channel embodiment is that mobile terminals assigned to monitor a multiplexed control channel can sleep during periods other than their allocated timeslot(s). That is, idle mobile terminals can reduce their standby power consumption by listening to the control channel for a small fraction of the time. For example, each net assigned to the control channel can listen only to its assigned timeslot of 0.66 ms within the repeating 20 ms frame. The assigned timeslot for a given net may be designated as the sleep mode slot for mobile terminals in that net. Thus, with 30 timeslots, up to 30 nets can share the same overhead channel, with each net having its own sleep mode slot to monitor as described above.

The exemplary mobile terminal wakes up in its own sleep mode slot and captures at least one sample per chip in memory, for the 2560 chip periods contained in the slot plus some guard periods on either end. The samples are then processed by digital signal processing such as by using a RAKE receiver in the mobile terminal as follows:
Correlation with the pilot code to establish a coherent reference, or to determine the weighting coefficients for a RAKE equalizer (RAKE taps);
Despreading with the overhead channel code to obtain complex values for each of the ten symbols periods in the slot, plus one or more optional guard symbols;
Using the RAKE coefficients to combine the complex values to obtain a single complex value for each of the ten symbols;
Soft-decoding the ten complex values to determine any or all of the following:
   (a) Whether the broadcast control channel code has been stolen for traffic or not;
   (b) If the broadcast control channel code has been stolen for traffic, whether the net for which the traffic is intended is the radio's own net or not;
   (c) If the broadcast control traffic has been stolen for a different net other than own net, determine the new code to which the broadcast control channel has been displaced;
Demodulating the samples using the indicated code of the broadcast control channel to receive broadcast control channel data; and
Demodulating own traffic, if so indicated, using the previous broadcast control channel code or an indicated downlink traffic channel.

With the ability to indicate a downlink traffic channel for the targeted net, it is no longer necessary to steal the broadcast control channel code for traffic; because the overhead channel, broadcast control channel, pilot code and traffic channel can all overlap, the overhead channel can equally well indicate the traffic code and the intended traffic recipient, and leave the broadcast control channel code unchanged. The fundamental reason for this is, that using CDMA, the mobile terminals do not need to change frequencies to receive an allocated channel. Instead, a mobile terminal can recover any encoded signal in its received wideband signal by merely retrospectively reprocessing the captured received signal samples held by it in buffer memory using the code or codes indicated by overhead channel decoding. This same flexibility can be achieved where the mobile terminals include wideband receivers and signal capture memory such that signals across a range of frequencies can be captured and then retrospectively processed at one or more frequencies of interest.

Indeed, a broadcast control channel is only needed at all if more information is required to be conveyed to more users than can be done using the overhead channel. However, it is equally efficient to use a single code at half the spreading factor, e.g., at 128 instead of 256, at twice the power level, as compared to using two codes with 256:1 spreading. These options are a matter of design choice and can be varied as needed or desired without departing from the present invention.

To provide late entry opportunities, sleep mode slots continue indicating the downlink channel codes assigned (as needed) to the corresponding nets monitoring the multiplexed control channel throughout the time that such data is being transmitted. To accommodate more than 30 nets in 30 timeslots, more overhead channels can be provided using different orthogonal codes, or else a longer frame with more slots can be used at the expense of some additional push-to-talk delays associated with extending the frame repeat time.

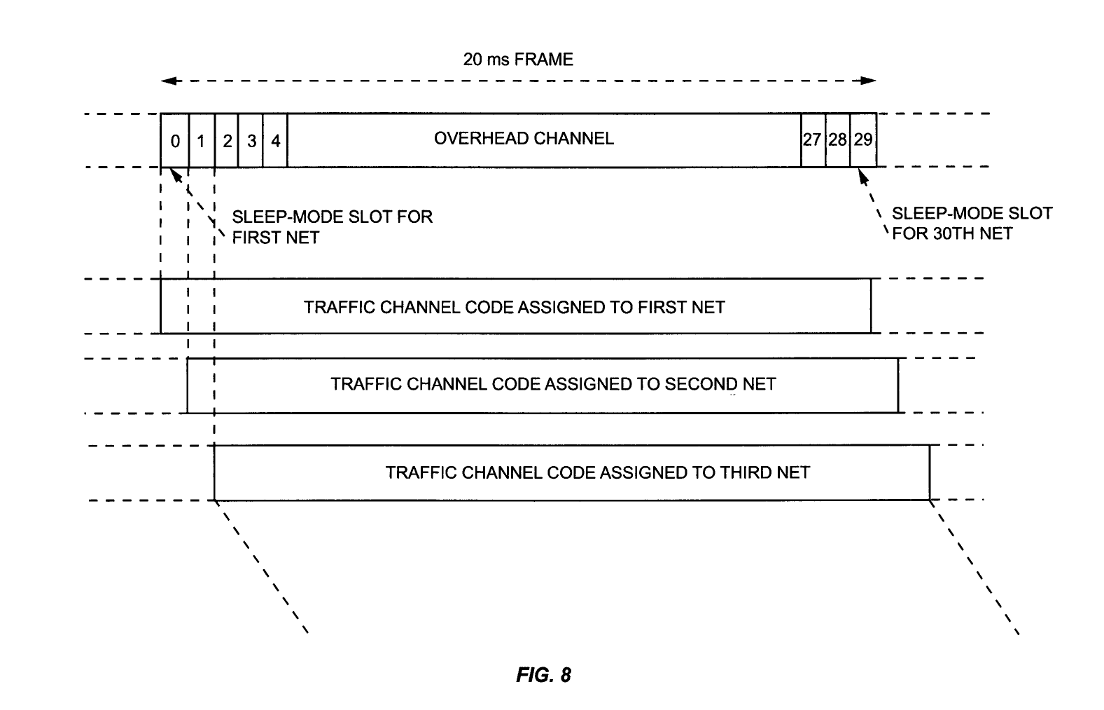

FIG. 8 illustrates the exemplary use of the available orthogonal code space and timeslots for the downlink of a dispatch system using CDMA. A 30-slot, 20 ms overhead channel code frame contains sleep-mode slots for up to 30 nets. When there is traffic for a net, the 10 symbols in the sleep-mode slot of that net indicate which traffic channel code is assigned to carry the retransmitted dispatch traffic for that net, and may also indicate the ID of the mobile terminal originating the dispatch traffic. The 10 symbols can comprise 20 un-coded QPSK bits that represent up to 1,048,576 codes. These codes can be used to indicate to the targeted net which one (or ones) of less than 30 orthogonal codes have been assigned to the targeted net for conveyance of the retransmitted dispatch traffic (and additional net or mobile specific traffic as needed or desired).

Typically, it would be of no interest to pool communication channels unless the 30 nets could share significantly fewer than 30 channels. For example, with CDMA code channels, 30 nets can share, for example, 16 codes. With 16 available codes, only 4 bits are needed to indicate the code. An additional number of bits may be used to indicate the ID of the originating mobile terminal. For example, where each net can have up to 256 members, 8 bits can be used to indicate which of up to 256 net members originated the traffic. Thus, a (20,12) code can be used, which should be designed such that the 4096 10-symbol patterns have maximum mutual Hamming distance between each other in the complex QPSK space. When a net contains fewer than 256 members, the codes assigned can be chose to obtain greater Hamming distance. Each net station would contain a list of the allowed members, which could be updated by an overhead message if it changes. When no traffic is passing for a net, its sleep mode slot can contain a default symbol pattern, for example just indicating the code used by the overhead channel itself. If desired, the assignment of 10 symbol patterns to represent 12 bits of data can be permuted from frame to frame according to a cipher algorithm. This can also increase the Hamming distance between different patterns when combining information from more than one successive sleep mode slot to improve correct detection.

If time duplex (TDD) is used to eliminate the need for antenna transmit receive duplexers in the mobile terminals, a given transmission occupies only a fraction of the 30 slots, for example 15, while another transmission may occupy the other half. The spreading factor is halved, however, to double the data conveyed in the 15 slots, thus maintaining the desired data rate. The number of channels available is the same, e.g., 16, but they are now described as using one of 8 orthogonal codes in either the first or the last 15 slots. The number of bits required to indicate the channel thus remains at four.

FIG. 8 indicates that the frame timing of a downlink traffic channel assigned to a net can staggered to start coincidentally with the corresponding sleep mode slot in the multiplexed downlink control channel corresponding to the targeted net. U.S. Pat. Nos. 5,539,730 and 5,566,168 to Applicant disclose one or more benefits gained by synchronizing the internal operation timing of a radio terminal to the timing of the channel assigned to it. Here, the alignment of a traffic frame start on the downlink traffic channel with the net's corresponding sleep mode slot ensures that the initial traffic data bits of the retransmitted dispatch traffic are detected.

The present invention also can use a constant delay of a whole number of slots between the sleep mode slot of a targeted net and the start (or continuation) or a traffic frame on the assigned downlink traffic channel. Such delay spacing allows a targeted mobile terminal to wake up, receive control traffic in its sleep mode slot, shut down all or part of its receiver circuit down, process the received data, determine that retransmitted dispatch traffic is available for it, turn its receiver circuit back on and configure it for reception on the assigned downlink traffic channel. That processing progresses at a finite speed and the delay from the net's sleep mode slot to the start of a traffic frame can be used to reduce or eliminate missed traffic associated with such processing delays at the mobile terminals.

With no such delay, a mobile terminal would have to continue receiving signal samples and committing them to memory in anticipation of a sleep-mode-slot decoding being indicative of traffic. If no traffic was indicated, the receiver could then power down, but would have been powered up longer than necessary. Therefore, a fixed delay time between the sleep mode slot and start of traffic is advantageous and can yield potentially significant power savings at the mobile terminals.

However, imposing such delays may reduce the time available for transmission if a symmetrical duplex mode is invoked and it is desired that transmission shall overlap neither the sleep mode slot nor the traffic receive period. Even if a mobile terminal uses more conventional telephone-type communications protocols for symmetrical duplex operation, if it is a dual-mode terminal that also belongs to a push-to-talk dispatch net, it may be required that it continue to listen to its dispatch net's control channel(s) during telephone operation, for a potentially preemptive message targeted to it.

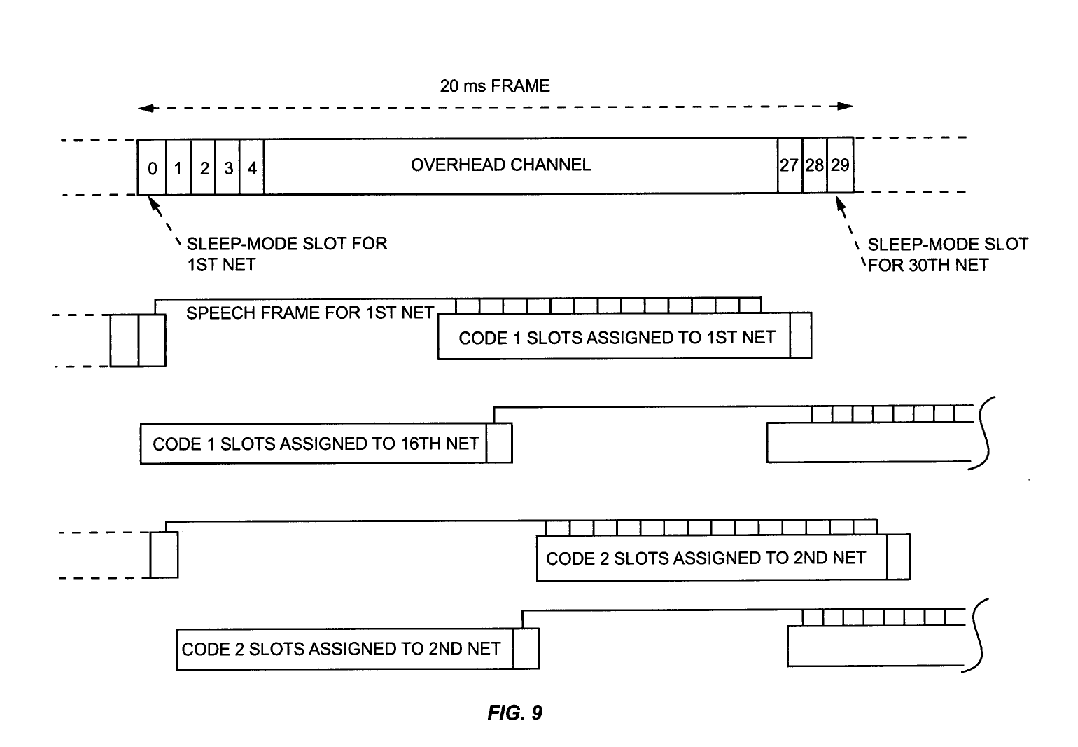

Various methods of accommodating such advanced services may be devised, including using only ⅓rd of the slots for reception, ⅓rd for transmission (if needed) and ⅓rd for monitoring other channels or for guard time or delay adjustment. If no time period for other use is required and it is desired to devote 50% of the time to transmit and 50% to receive, this may be accomplished using the format of FIG. 9.

In FIG. 9, 15 out of 30 slots on a first code are assigned to one net and the other 15 to another net. However, there is a delay of 15 slots between the end of the sleep mode slot and the first slot of the next block of 15 traffic slots. The last of the block of traffic slots now coincides with the sleep-mode-slot instead of the first. To reduce delay in decoding valid speed frames however, a speech frame spans the last slot of one block (i.e. the sleep mode slot) and the first 14 of the next block. Thus, when a sleep mode slot has been processed and indicates traffic is present, the first slot of a speech frame is already available to be decoded by retrospectively reprocessing the sleep-slot signal samples, while a delay of 15 slots is available before the receiver need reawaken to continue receiving traffic. Thus, the sleep-mode slot decoding may take up to approximately 15 slots without prolonging the mobile terminal's receiver power up period to wait for the decoding to be completed.

No guard time is included adjusting the transmit timing to compensate for transmission delay. Therefore, the time of arrival of a transmission from a mobile terminal depends on its distance from the network's receiving station and/or orbiting satellite relay station if such is used in network 10. Thus, dispatch traffic originating from mobile terminals in two different nets transmitting at different times may nevertheless be received partially overlapping at network 10. This is no problem unless orthogonal codes are used on the uplink. The network's receiving station can afford more advanced processing, interference cancellation for example, to take care of such overlap and thereby compensating for non-orthogonality. Network 10 can, however, have difficulty detecting a first transmission by an originating mobile terminal, if the time-of-arrival is unknown to a large uncertainty, due to the need to correlate for the terminal's spreading code with any different chip-spaced timing shifts.

Therefore, it is helpful to provide a system of mobility management that informs the network 10 roughly of the location or loop delay to each mobile terminal and updates the information when any terminal's loop delay changes by more than a threshold amount. The network's receiving station(s) can then center the correlation searches for traffic from any mobile terminal around the expected times-of-arrival of that traffic.

The desire to reduce power consumption—and thereby extend the battery life of portable communication devices—is thus addressed by the present invention within the context of push-to-talk dispatching. With the slotted configuration of the exemplary downlink control channel described above, the standby battery consumption of a mobile terminal 24 can be reduced by a factor approximately equal to the number of sleep-mode slots employed. If one slot is to be received by all mobile terminals, e.g., a common control channel slot for signaling to all mobile terminals 24, the power saving factor is roughly 2/N where N is the number of sleep mode slots.

In a conventional cellular system, the repetition period of sleep-mode slots is of the order of two seconds, which would cause an excessive delay for dispatch operation. Consequently, the sleep-mode repetition period for dispatch use should be much shorter. It is possible to use a dual period, in which nets that have been idle for a significant time wake up to receive their sleep mode slot infrequently, but as soon as a new communication is initiated, all members of the net resume receiving every sleep mode until there has been no communication for a defined time period, at which point they resume the lower duty factor sleep mode. In this way, large battery saving factors may be achieved for relatively dormant nets and standby power saving modes may be used as part of the current invention without negating the dispatch delay improvements.

For example, a 10 ms frame period can be defined containing 8 timeslots of 1.25 ms each. A mobile terminal 24 wakes up to receive one of the eight slots as a broadcast control channel and another as its own control channel. Nets are assigned more or less uniformly across the seven control channel slots. The standby power saving factor in this case is 4:1.

When a mobile terminal 24 initiates a transmission, it may use all eight slots, which then would all contain the indication of the new channel to which the control channel was displaced. A given mobile terminal may first be alerted to the control channel change by receiving the indication in the broadcast control channel slot, which may always be the first in the frame. It would then retune or reconfigure to receive its control channel slot on the indicated channel. If the new channel indication was indistinct due to noise, the mobile terminal could choose to receive any other slot, for example, the slot immediately following the broadcast control channel slot, in a further attempt to determine the new control channel.

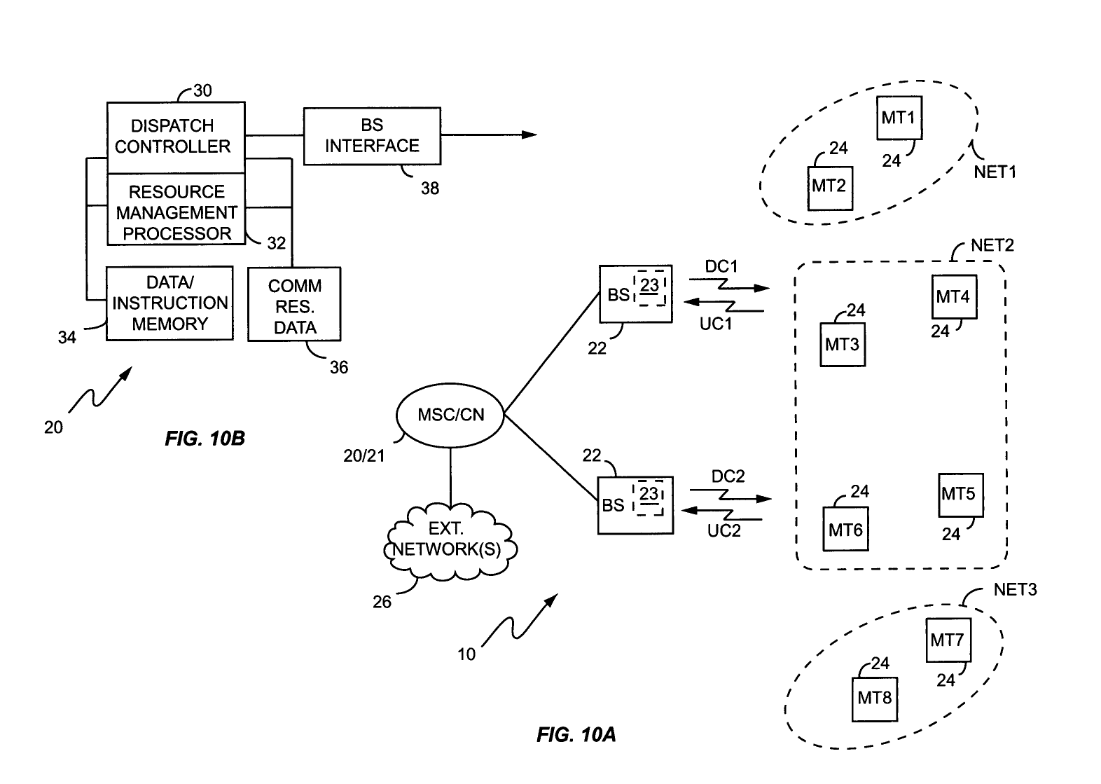

With any or all such details and considerations in mind, FIG. 10A illustrates one embodiment for network 10, wherein it comprises a cellular radio based push-to-talk dispatch communication network with reduced dispatching delays. Here, network 10 comprises a Mobile Switching Center (MSC) 20 in or associated with a Core Network (CN) 21, and a plurality of Base Stations (BSs) 22. BSs 22 include radio transceiver resources 23, e.g., assignable radio transmitters and receivers, demodulators, detectors, frequency and timing references, etc. as needed to support dispatching (and other) radio communications with mobile terminals 24.

As such, each BS 22 can be configured to operate as both a receiving and a transmitting station for network 10 in support of dispatch communications among the mobile terminals 24. Further, while the focus of this discussion is on the dispatching operations of network 10, it should be noted that network 10 may provide for communication between one or more of the mobile terminals 24 and users of external networks 26, such as the Public Switched Telephone Network (PSTN), the Internet, etc., if the mobile terminals 24 are so configured.

By way of example, first and second mobile terminals 24, denoted as MT1 and MT2, belong to a first net, NET1, having shared uplink and downlink control channels, UC1 and DC1, respectively, allocated at one of the BSs 22. Terminals MT3 and MT4 also share UC1 and DC1 but belong to a different net, designated as NET2. Terminals MT5 and MT6 also belong to NET2 but they are in a different geographic area and thus are supported on a different BS 22 that provides shared uplink and downlink control channels UC2 and DC2. Terminals MT7 and MT8 in yet another net, NET3, also are assigned to UC2 and DC2.

In one scenario, MT3 originates dispatch traffic for NET2 and network 10 detects that incoming traffic on UC1. As explained, with channel stealing, network 10 steals shared downlink control channels as needed for retransmission of the dispatch traffic from MT3 to the other mobile terminals 24 that are members of NET2. Thus, network 10 steals DC1 for retransmission of the dispatch traffic to MT4, and also can steal DC2 for retransmission of the dispatch traffic to MT5 and MT6. Further, as explained, network 10 sends indications of new downlink control channel assignments on the stolen channels so that mobile terminals 24 in the non-targeted nets immediately can switch to monitoring the newly assigned downlink control channel for traffic targeted to them.

In this scenario, then, dispatch traffic from MT3 is delivered to MT4 via DC1 and MT5 and MT6 via DC2. Meanwhile, the mobile terminals 24 in NETS 1 and 3 move to new downlink control channels. When MT3 ends its dispatch, it and MT4 move to the currently assigned downlink control channel(s). Network 10 may select the channels to use for reassignment from a common pool that may or may not be shared with the network at large. For example, a pre-selected set (or sets of channels) in one or more service areas may be selected for reassignment use with a particular group of nets.

Of course, if network 10 employs the multiplexing approach described earlier herein—i.e., DC1 and DC2 include a plurality of sleep mode slots for different nets assigned to them—the downlink control channels are not stolen but rather are used to indicate additional (traffic) channel assignments as needed for targeted nets. Thus, network 10 would simply indicate the selected traffic channels for MT3's dispatch traffic in timeslots on DC1 and DC2 and MT4, MT5, and MT6 would configure their respective receivers for receipt of that dispatch traffic according to the received channel assignment information.

FIG. 10B illustrates exemplary processing elements for MSC 20 that can be used to support the present invention in any of its embodiments. With regard to its elements supporting the present invention, the exemplary MSC 20 comprises a dispatch controller 30, a resource management processor 32, data and instruction memory 34, communication resource data 36 relating to the availability and configuration of pooled communication channel resources, and a BS interface 38 to send and receive signals to and from BSs 22 in support of dispatching control.

While this functional arrangement may be implemented in hardware, software, or both, an exemplary MSC 20 includes one or more microprocessor-based circuits having access to control and signaling data in support of dispatching control. As such, the exemplary dispatching processing described herein may be embodied as a computer program stored in a computer readable medium. The program may comprise program instructions to carry out processing in support of any or all of the embodiments described herein, and may take the form of software, firmware, microcode, etc. To that end, memory 34 may comprise one or more memory devices, such as Dynamic Random Access Memory (DRAM), Static RAM (SRAM), and non-volatile memory (solid state, disk, tape, etc.).

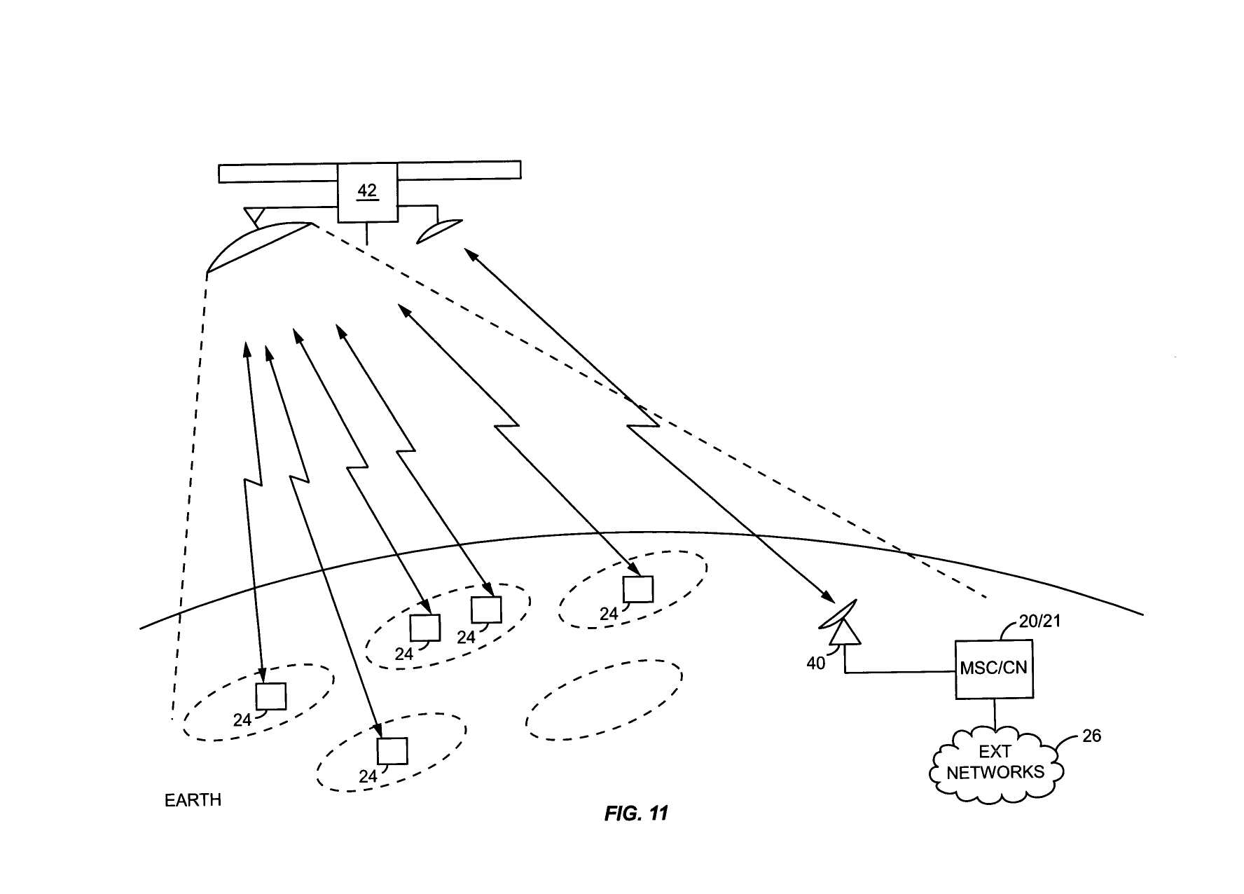

While the present invention offers reduced dispatching delays in a variety of network types, those reductions can dramatically improve system performance in the case of satellite-based networks and mixed cellular-satellite networks. Such an embodiment is illustrated in FIG. 11. Here, network 10 includes a ground station 40 coupled to MSC 20 and/or to CN 21 that provides feeder uplinks and downlinks to an orbiting satellite relay station 42 that may be positioned in geo-synchronous orbit to thereby provide push-to-talk communication coverage to mobile terminals 24 in one or more radio nets over a potentially large service area (or areas).

Since each uplink and downlink “hop” through the satellite relay 42 requires roughly 130 ms of signal transit time, a round-trip from a mobile terminal 24 to MSC 20 and back requires about 260 ms without figuring in any signal processing delays. If a mobile terminal 24 had to negotiate a channel/grant request before sending dispatch traffic, it would incur a minimum further delay of an additional 260 ms for round-trip handshaking with network 10.

That amount of minimum delay stack-up would be intolerable in push-to-talk environments. Thus, the present invention's elimination of the need for explicit channel request/grant handshaking makes the use of intermediate satellite relay stations viable in push-to-talk communication networks and that makes such networks substantially more flexible and powerful. That is, because network 10 is configured for random detection of incoming dispatch traffic on any of its available shared uplink channels, an originating mobile terminal 24 can send its dispatch traffic on an uplink channel immediately without waiting for any indication from the network 10.

As noted, network 10 can include an indication of mobile terminal identity in the retransmission of dispatch traffic, thereby allow originating mobile terminals 10 to determine whether they successfully seized an uplink channel or lost out to another originating mobile terminal sharing the same uplink channel. If the mobile terminal “lost” a dispatch because of such contention on the uplink channel, it may immediately send its dispatch traffic on another uplink channel, or may wait until it sees that dispatch traffic on its current uplink channel has ended.

Note that the present invention in this and in other embodiments thus offers the ability to decouple the uplink and downlink channels used by a given group of nets. Even with control channel stealing, mobile terminals 24 in the non-targeted nets may move to a new downlink channel but may retain their uplink channel assignment. Of course, if desired, the network 10 may make uplink channel reassignments as needed or desired. It also may designate one or more uplink channels as alternative dispatch channels to be used for mobile terminals 24 if another mobile terminal 24 has seized the primary uplink channel.

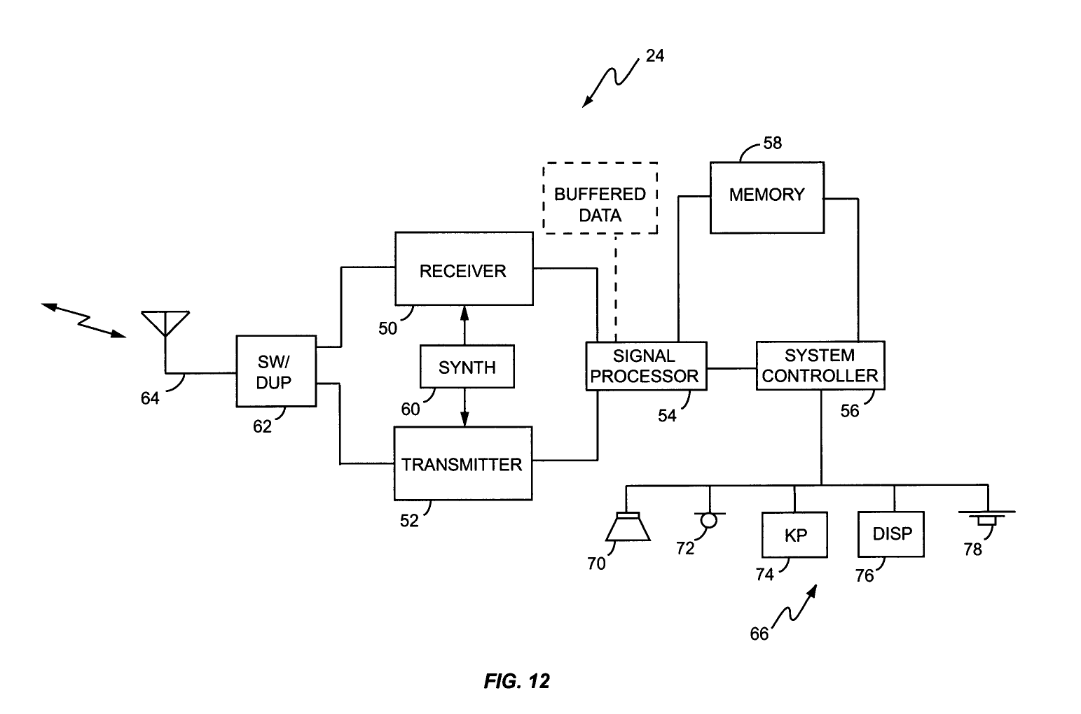

This processing and all other processing described herein for mobile terminals may be supported by the exemplary mobile terminal 24 illustrated in FIG. 12. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (G PS) receiver; and a conventional laptop and/or palmtop receiver or other appliance that includes a radiotelephone transceiver. Mobile terminals also may be referred to as “pervasive computing” devices.

In any case, the exemplary mobile terminal 24 comprises a receiver circuit 50, a transmitter circuit 52, a signal processor 54 (e.g., DSP), a system controller 56 (e.g., microprocessor/microcontroller), one or more memory devices 58, a frequency synthesizer 60, a switch/duplexer circuit 62, a receive/transmit antenna assembly 64, and a user interface 66. An exemplary user interface includes audio input/output transducers 70 and 72, e.g., a speaker and a microphone, a keypad 74, a display screen 76, e.g., a multi-line graphical display screen, and a push-to-talk button 78 supporting dispatch mode communication. It should be noted that the push-to-talk button 78 need not be explicitly implemented, and could be included in keypad 76 or even offered as a soft key on display 76. These and other details of the user interface 66 may have practical design value but are not germane to the present invention.

Of interest with respect to the invention, the exemplary mobile terminal processing may be embodied as a computer program stored in a computer readable medium, e.g., in memory 58. Signal processor 54 and system controller 56 may share memory, or each may have their own dedicated program and data memory, which may or may not be integrated with them and either or both of them may support exemplary dispatch communication processing.

Receiver 50 can include amplifiers, filters, and digitizers as needed to generate signal samples corresponding to the incoming received signal(s) impinging on antenna assembly 64. As such, receiver 50 may include buffer memory for holding a desired number of signal samples, a received signal buffer in other words. The buffer may be implemented in other memory and its details are not material so long as signal processor 54 can access the data (or copies of it) to perform the retrospective data processing described earlier herein. For example, signal processor 54 can decode buffered data using one spreading code (or frequency) to recover a first signal, and then run back through the data using a second code (or frequency) to recover a second signal.

In push-to-talk dispatching, a user of mobile terminal 24 presses push-to-talk button 78 or the like, and speaks into microphone 72. Mobile terminal 24 begins encoding the incoming audio and activates its transmitter 52 for immediate transmission of the data on an assigned uplink channel—i.e., it does not wait for permission to send the data nor does it handshake with network 10. Such encoding-and-transmission continues while button 78 remains depressed, allowing the user of mobile terminal 24 to continue talking. Of course, this same operation could be used to flash other types of traffic to network 10 for immediate delivery to other mobile terminals in a designated group or net, e.g., instant messages and other non-speech data.

Thus, an exemplary mobile terminal 24 for use in a push-to-talk communication network with reduced dispatching delays may comprise a receiver circuit to receive retransmitted dispatch traffic on a downlink control channel shared by mobile terminals in one or more radio nets, and a processor circuit to monitor the downlink control channel to detect whether the network is retransmitting dispatch traffic targeted to the radio net of the mobile terminal, and to process the retransmitted dispatch traffic if it is targeted to the radio net of the mobile terminal. The processor circuit may be configured to monitor the downlink control channel for an indication of a new downlink control channel assignment and to switch the receiver circuit to begin monitoring the new downlink control channel if the retransmitted dispatch traffic is not targeted to the radio net of the mobile terminal, and may be configured to monitor the downlink control channel to detect whether the network is retransmitting dispatch traffic targeted to the radio net of the mobile terminal by receiving retransmitted dispatch traffic on the downlink control channel and recovering an indication of radio net identity from the retransmitted dispatch traffic.

If the retransmitted dispatch traffic is not targeted to the radio net of the mobile terminal, the processor circuit may be configured to switch the receiver circuit to begin monitoring a new downlink control channel responsive to detecting an indication of a new downlink control channel assignment transmitted on the downlink control channel after an end of the retransmitted dispatch traffic. Conversely, the processor circuit may be configured to process the retransmitted dispatch traffic if it is targeted to the radio net of the mobile terminal by recovering a radio net identity from the retransmitted dispatch traffic and selectively recovering transmitted data from the retransmitted dispatch traffic if the radio net identity matches that of the mobile terminal.

In embodiments where the downlink control channel comprises a multiplexed downlink control channel, the processor circuit may be configured to detect whether the network is retransmitting dispatch traffic targeted to the radio net of the mobile terminal by monitoring an allocated sub-channel of the multiplexed downlink control channel for an indication that the network is or will be retransmitting dispatch traffic targeted to the radio net of the mobile terminal. In this context, the processor circuit is configured to configure its associated receiver circuit to receive the retransmitted dispatch traffic on the identified downlink traffic channel.

In embodiments where the downlink control channel is stolen (i.e., converted to traffic use), an exemplary mobile terminal 24 comprises a receiver-transmitter terminals that comprises a receiver to decode a relay station signal and to determine whether, in a first case, the relay station signal is indicative of an idle control channel, or, in a second case, is indicative of an active traffic channel carrying traffic intended for the terminal, or, in a third case, is indicative of an active traffic channel carrying traffic not intended for the terminal, and a transmitter to transmit a terminal signal to a relay station using a first signal format in the first case, using a second signal format in the second case, and to terminate transmission in the third case.

The receiver further may be configured to determine whether, in a fourth case, the relay station signal is indicative of an active traffic channel carrying an end-of-message indication intended for the terminal, and the transmitter may be configured to transmit the terminal signal using a third signal format that indicates an end-of-message until the receiver of the terminal detects the fourth case. Further, the mobile terminal 24 may be configured to initiate a transmission of traffic to a relay station and, upon completing transmission of the traffic, transmit an end-of-message indicator to the relay station until the terminal 24 detects a corresponding end-of-message indicator in the relay station signal being transmitted from the relay station.

Turning from the exemplary mobile terminal 24 back to network processing details, it should be noted that the present invention may include exemplary channel resource management for pooled communication resources. The earlier illustrated resource management processor (controller) 32 or other network entity may manage the pools of communication channels that are trunked for use by groups of radio nets. Managing a plurality of radio nets may comprise assigning groups of radio nets to shared uplink and downlink channels selected from one or more pools of channel resources at the network 10, and further comprising reassigning radio nets from one group to another as needed to maintain an average duty factor of each group within a desired range. Thus, controller 32 may remove particularly high duty factor radio nets from their respective groups and individually assign them to uplink and downlink channels not shared by other radio nets.

For example, the activity or duty factor-the frequency and extent of its dispatch communication events—of a net may vary with time, being unsuitable for trunking at periods of high activity but suitable for trunking during periods of low activity. Further, a geostationary satellite's coverage area(s) may span many time zones and net traffic may wax and wane among the different time zones. For these and other reasons, therefore, the present invention may dynamically vary how the radio nets are served, i.e., network 10 may manage the assignment of nets to pooled channels or to dedicated channels, according to varying activity factors.

Additionally, many low duty-factor nets can be assigned to listen to the same control channel, while a smaller number of high duty-factor nets can share a different control channel. Nets with duty factory higher than about 25% may not be suitable to be trunked, and nets that reach such levels of activity may be assigned a unique channel for the duration of the period of high activity. Control channels may be divided into sleep-mode slots and every net assigned a unique sleep-mode slot to avoid contention. Thus, resource management processor 32 may implement various methods of accomplishing these and other channel assignment methods.

A first exemplary resource management method is a semi-manual method: management controller 32, anticipating a period of high activity for a given net, enters a request for a dedicated channel. Normally, unless the net is near saturation with ongoing dispatch traffic, such a request would be fulfilled immediately apart from propagation delays, say within 2 seconds. The result would be a message on the control channel addressed to all members of the net, informing them of a dedicated channel assignment. Mobile terminals 24 in the affected net may continue to monitor both the shared and the newly assigned dedicated control channels afterwards. Network 10 may repeat its transmission of the dedicated channel assignment information so that mobile terminals 24 in the affected net that might have missed an earlier transmission on the shared control channel are given additional opportunities to receive the assignment information.

A second, automatic method can comprise monitoring net activity, such as at the management processor 32, and allocating a dedicated channel to any net observed to have a high activity factor. In a secure or military system, the central monitoring location may be made physically secure and all communications protected by ciphering and other transmission security measures to deny a potential adversary access to useful information based on surreptitious traffic flow analyses. Such measures would deny unauthorized parties from gleaning information regarding the communication activity level of any net.

Other reasons for dynamically changing channel allocations can arise. For example, when the total activity of all nets sharing the same pooled channels threatens to rise above that which can be supported in the given channels without undue blocking, then either the number of channels in the pool allocated to the currently assigned group of nets can be increased, or one or more high activity nets can be allocated dedicated channels until their activity subsides.

In this sense, the management processor 32 can be configured to maintain something of a balance in the relative activity factors among the groups of nets allocated to different channel pools. For example, relatively high activity factor nets may be removed from a first group of nets and placed into a second group of nets having a different pool of trunked channels if the overall activity factor of the first group is higher than that of the second group. Following this logic, a very high activity net if not allocated dedicated channels outright could be moved to a grouping of nets that currently has a very low activity factor.

In general, such balancing methods may be targeted to maintaining desired average levels of activity across groups of nets. Alternatively, such methods may be targeted to ensuring that the average activity factor of any given net does not rise above a defined threshold that may be set at, for example, a level where further rises in activity are expected to result in undesirable levels of blocking and contention.

The desire to circumvent blocking can be a reason for allocating a dedicated channel to a given net with a high activity factor. If a net member pushes-to-talk, and all channels available for that net are in use, so that the control channel cannot be displaced elsewhere, then the return control channel link, instead of carrying the net's traffic, may carry a control message allocating a channel outside the immediate pool of channels, such as a channel from a different pool that is not overloaded. Indeed, the message can signify to members of the blocked net that they have been transferred to a different pool in which activity is not so high. In other words, if a mobile terminal 24 attempts to originate dispatch traffic in a congested grouping of nets, the network 10 may use that as trigger to move that net to another grouping of nets that have control channels available.

Alternatively, the originating mobile terminal 24 may grab the uplink control channel as usual so as to provide a fast response, but a message can be sent from the network 10 to the net by associated channel signaling either during the traffic or after the traffic but before the EOM indicator to effect the reallocation of the net to a different channel or pool. If necessary, for the short length of time that this takes, during which the control channel is effectively unavailable to other nets, a busy indication can be provided at other terminals attempting to initiate a transmission. This situation would prevail only for a second or so and only very occasionally. Thus, an automatic assignment of nets to channel pools can be made that results in acceptably low blocking probability. Ultimately, no communication need be blocked if there is at least one channel available for carrying the dispatch traffic in the service area or areas of the targeted net.

Given the above range of details, those skilled in the art should appreciate the broad scope of the present invention. Although several exemplary embodiments were described, the present invention should be understood as broadly providing reduced dispatching delays in a dispatch communication network. Its various embodiments differ in selected implementation details but provide the common benefit of immediate dispatch traffic transmission from originating mobile terminals 24 to the network 10 without requiring channel request/grant handshaking on either the uplink or the downlink. As such, the present invention is not limited by the foregoing discussion and the accompanying illustrations but rather is limited only by the following claims and their reasonable equivalents.

1. A method of reducing dispatching delays in a push-to-talk radio network, the method comprising:
assigning a pool of downlink channels to be shared by a group of radio nets;
monitoring one or more uplink channels associated with mobile terminals in the group of radio nets for dispatch traffic such that the mobile terminals can transmit dispatch traffic to the network on the one or more uplink channels without need for explicit channel grant/request procedures;
receiving dispatch traffic from an originating one of the mobile terminals; and
retransmitting the dispatch traffic on one of the downlink channels that currently is selected as a downlink control channel for the group, along with transmitting an indication of radio net identity of the originating mobile terminal to enable other mobile terminals in the radio net of the originating mobile terminal to recognize the dispatch traffic as being targeted to them.

2. The method of claim 1, further comprising transmitting an indication of control channel reassignment on the selected downlink control channel along with retransmitting the dispatch traffic to enable mobile terminals not in the radio net of the originating mobile terminal to move to a newly selected downlink control channel as indicated by the indication of control channel reassignment.

3. The method of claim 2, further comprising selecting the newly selected downlink control channel from the pool of downlink channels.

4. The method of claim 2, further comprising periodically repeating transmission of the indication of control channel reassignment on the selected downlink control channel.

5. The method of claim 4, further comprising updating the indication of control channel reassignment being transmitted on the selected downlink control channel to reflect any subsequent control channel reassignments.

6. The method of claim 1, further comprising transmitting an indication of mobile terminal identity of the originating mobile terminal on the selected downlink control channel along with retransmitting the dispatch traffic.

7. The method of claim 1, further comprising transmitting an end-of-message indicator on the downlink control channel to indicate an end of dispatch traffic from the originating mobile terminal.

8. The method of claim 1, wherein the uplink and downlink channels comprise at least one of selected channel frequencies, selected time slot assignments within TDMA frames, and selected spread spectrum spreading code assignments.

9. The method of claim 8, wherein the selected spread spectrum spreading codes comprise one or more frequency-hopping sequences.

10. The method of claim 8, wherein the spread spectrum spreading codes comprise a direct sequence spreading code.

11. The method of claim 1, wherein receiving dispatch traffic from an originating one of the mobile terminals comprises receiving the dispatch traffic at a network ground station via relay through an associated satellite relay station.

12. The method of claim 1, wherein retransmitting the dispatch traffic on one of the downlink channels that currently is selected as a downlink control channel for the group, along with transmitting an indication of radio net identity of the originating mobile terminal to enable other mobile terminals in the radio net of the originating mobile terminal to recognize the dispatch traffic as being targeted to them comprises transmitting from a network ground station to an associated satellite relay station for retransmission to the mobile terminals.

13. A method of reducing dispatching delays in a push-to-talk radio network, the method comprising:
allocating a pool of channels to be shared by a plurality of radio nets;
using one or more downlink channels in the pool as downlink control channels;
associating one or more uplink channels with each downlink control channel and assigning one or more radio nets to each downlink control channel;
monitoring the one or more uplink channels for dispatch traffic from mobile terminals assigned to the one or more uplink channels to thereby enable transmissions of dispatch traffic from the mobile terminals to the network without need for explicit channel/grant request procedures;
receiving dispatch traffic from an originating mobile terminal in one of the radio nets assigned to the one or more uplink channels; and
transmitting downlink traffic channel assignments on the associated downlink control channel for receipt by mobile terminals in the radio net of the originating mobile terminal and, substantially, at the same time, retransmitting the dispatch traffic from the originating mobile terminal on one or more downlink traffic channels corresponding to the downlink traffic channel assignments.

14. The method of claim 13, wherein each downlink control channel comprises a time-multiplexed channel having one or more timeslots, with each timeslot being allocated to one of the radio nets assigned to the downlink control channel, and wherein transmitting downlink traffic channel assignments on the associated downlink control channel for receipt by mobile terminals in the radio net of the originating mobile terminal comprises transmitting downlink traffic channel information in the timeslot allocated to the radio net of the originating mobile terminal.

15. The method of claim 14, further comprising associating a set of available downlink channel resources with the multiplexed downlink control channel, and wherein transmitting downlink traffic channel information the timeslot allocated to the radio net of the originating mobile terminal comprises transmitting a downlink traffic channel assignment corresponding to a downlink traffic channel selected from the available downlink channel resources.

16. A method of reducing dispatching delays in a push-to-talk radio network, the method comprising:
assigning mobile terminals belonging to one or more radio nets to a shared uplink channel;
detecting transmission of dispatch traffic on the shared uplink channel from an originating mobile terminal in one of the radio nets; and
retransmitting the dispatch traffic on a downlink channel assigned to the radio net of the originating mobile terminal.

17. The method of claim 16, wherein the downlink channel assigned to the radio net of the originating mobile station is a shared downlink channel shared by mobile terminals in the one or more radio nets, and wherein retransmitting the dispatch traffic on a downlink channel assigned to the radio net of the originating mobile terminal comprises retransmitting the dispatch traffic on the shared downlink control channel.

18. The method of claim 17, further comprising transmitting an indicator of radio net identity on the shared downlink channel along with retransmitting the dispatch traffic to enable mobile terminals sharing the shared downlink channel to determine whether they should process the retransmitted dispatch traffic based on belonging to the radio net of the originating mobile terminal.

19. The method of claim 17, further comprising transmitting an indicator of mobile terminal identity on the shared downlink channel along with retransmitting the dispatch traffic to enable the originating mobile terminal to determine that it has seized the shared uplink channel.

20. The method of claim 17, further comprising transmitting an indicator of a new shared downlink channel assignment on the shared downlink channel along with retransmitting the dispatch traffic to enable mobile terminals sharing the shared downlink channel that are not in the radio net of the originating mobile terminal to begin monitoring a new shared downlink channel.

21. The method of claim 17, further comprising repeating the transmission of the indicator of the new shared downlink channel assignment periodically.

22. The method of claim 17, further comprising transmitting an indicator of subsequent new shared downlink channel assignments as needed on the shared downlink channel.

23. The method of claim 17, further comprising transmitting an indication of a new shared uplink channel on the shared downlink channel.

24. The method of claim 17, further comprising transmitting an indicator of a new shared uplink channel and a new shared downlink channel on the shared downlink channel.

25. The method of claim 17, further comprising transmitting an end-of-message indicator on the shared downlink channel to indicate an end of dispatch traffic from the originating mobile terminal.

26. The method of claim 25, further comprising repeating the transmission of the end-of-message indicator on the shared downlink channel one or more times.

27. The method of claim 26, wherein repeating the transmission of the end-of-message indicator on the shared downlink channel one or more times comprises repeating transmission of the end-of-message indicator until detected by the originating mobile terminal.

28. The method of claim 16, wherein a multiplexed downlink channel is assigned to the one or more radio nets, and wherein retransmitting the dispatch traffic on a downlink channel assigned to the radio net of the originating mobile terminal comprises:
transmitting a downlink traffic channel assignment on the multiplexed downlink channel for the radio net of the originating mobile terminal; and
substantially at the same time, retransmitting the dispatch traffic on an assigned downlink traffic channel corresponding to the downlink traffic channel assignment.

29. The method of claim 28, wherein transmitting a downlink traffic channel assignment on the multiplexed downlink channel for the radio net of the originating mobile terminal comprises transmitting the downlink traffic channel assignment in one or more timeslots of the multiplexed downlink channel that are allocated to the radio net of the originating mobile terminal.

30. The method of claim 28, wherein retransmitting the dispatch traffic on the assigned downlink traffic channel comprises transmitting an initial portion of a defined speech frame coincident with one of the timeslots allocated to the radio net of the originating mobile terminal, suspending transmissions for a defined interval corresponding to a mobile terminal wake-up time, and then resuming transmission of a remaining portion of the speech frame.

31. The method of claim 16, further comprising managing a plurality of radio nets by assigning groups of radio nets to shared uplink and downlink channels selected from one or more pools of channel resources at the network, and further comprising reassigning radio nets from one group to another as needed to maintain an average duty factor of each group within a desired range.

32. The method of claim 31, further comprising removing particularly high duty factor radio nets from their respective groups and individually assigning them to uplink and downlink channels not shared by other radio nets.

33. A communications system using orthogonal spread spectrum coding and providing reduced dispatching delays, the system comprising:
an overhead control channel transmitted using a first orthogonal code, the overhead control channel being divided into timeslots, each timeslot being assigned to a given group of mobile terminals that form a radio net;
a random access receiver to detect transmissions initiated by any originating one of the mobile terminals; and
encoding and decoding circuits to decode the detected transmissions and re-encode them on a currently unassigned second orthogonal code, and to encode an indication of the second orthogonal code for transmission in the overhead control channel timeslot assigned to the radio net of the originating mobile terminal.

34. The system of claim 33, wherein an identification of the originating mobile terminal also is encoded by said encoder into the overhead control channel timeslot assigned to the radio net to which the originating mobile terminal belongs.

35. The system of claim 33, wherein the decoding circuit is configured to detect a specific End-of-Message (EOM) code and re-encode the EOM for retransmission in the overhead control channel timeslot one or more times before reverting the overhead control channel transmission to an idle pattern.

36. The system of claim 35, wherein the originating mobile terminal continues to transmit the EOM code until the re-encoded EOM is detected by the originating mobile terminal, whereupon the originating mobile terminal ceases transmission.

37. The system of claim 35, wherein the re-encoded EOM is transmitted until the system detects that the originating mobile terminal has ceased transmission.

38. A communication network that provides reduced dispatching delays in push-to-talk radio communications, wherein mobile terminals in one or more radio nets are assigned to one or more uplink channels, the network comprising:
a network receiver configured to detect random access transmissions of dispatch traffic on the one or more uplink channels from an originating mobile terminal in one of the radio nets; and
a network transmitter to retransmit the dispatch traffic on a downlink channel assigned to the radio net of the originating mobile terminal.

39. The network of claim 38, wherein a shared downlink channel is associated with the one or more uplink channels and is shared by the one or more radio nets, and wherein the network transmitter is configured to retransmit the dispatch traffic on the shared downlink channel.

40. The network of claim 39, wherein the network transmitter is configured to transmit an indicator of radio net identity on the shared downlink channel along with retransmitting the dispatch traffic so that mobile terminals sharing the shared downlink channel can determine whether they are in the radio net of originating mobile terminal and therefore should process the dispatch traffic being retransmitted by the network.

41. The network of claim 39, wherein the one or more uplink channels comprise a shared uplink channel shared by the one or more radio nets, and wherein the network transmitter is configured to transmit an indicator of mobile terminal identity on the shared downlink channel along with retransmitting the dispatch traffic so that the originating mobile terminal can determine that it has seized the shared uplink channel.

42. The network of claim 39, wherein the network transmitter is configured to transmit an indicator of a new shared downlink channel assignment on the shared downlink channel along with retransmitting the dispatch traffic so that mobile terminals sharing the shared downlink channel that are not in the radio net of the originating mobile terminal can begin monitoring a new shared downlink channel.

43. The network of claim 42, wherein the network transmitter is configured to repeat the transmission of the indicator of the new shared downlink channel assignment one or more times.

44. The network of claim 42, wherein the network transmitter is configured to transmit indicators of subsequent new shared downlink channel assignments as needed on the shared downlink channel.

45. The network of claim 39, wherein the network transmitter is configured to transmit an end-of-message indicator on the shared downlink channel to indicate an end of dispatch traffic from the originating mobile terminal.

46. The network of claim 45, wherein the network transmitter is configured to repeat transmission of the end-of-message indicator on the shared downlink channel one or more times.

47. The network of claim 38, wherein the network transmitter is configured to provide a multiplexed downlink channel to which the one or more radio nets are assigned, and wherein the network transmitter is configured to retransmit the dispatch traffic on a downlink traffic channel assigned to the radio net of the originating mobile terminal by:
transmitting a downlink traffic channel assignment on the multiplexed downlink channel for the radio net of the originating mobile terminal; and
substantially at the same time, retransmitting the dispatch traffic on an assigned downlink traffic channel corresponding to the downlink traffic channel assignment transmitted on the multiplexed downlink channel.

48. The network of claim 47, wherein the network transmitter is configured to transmit the downlink traffic channel assignment on the multiplexed downlink channel for the radio net of the originating mobile terminal by transmitting the downlink traffic channel assignment in one or more timeslots of the multiplexed downlink channel that are allocated to the radio net of the originating mobile terminal.

49. The network of claim 48, wherein the network transmitter is configured to retransmit the dispatch traffic on the assigned downlink traffic channel by transmitting an initial portion of a defined speech frame coincident with one of the timeslots allocated to the radio net of the originating mobile terminal, suspending transmissions for defined interval corresponding to a mobile terminal wake-up time, and then resuming transmission of a remaining portion of the speech frame.

50. The network of claim 38, further comprising a resource management processor configured to manage a plurality of radio nets by assigning groups of radio nets to shared uplink and downlink channels selected from one or more pools of channel resources at the network, and further by reassigning radio nets from one group to another as needed to maintain an average duty factor of each group within a desired range.

51. The network of claim 50, wherein the resource management processor is configured to remove particularly high duty factor radio nets from their respective groups and individually assigning them to uplink and downlink channels not shared by other radio nets.

52. A method of providing push-to-talk communications with reduced dispatching delays at a first mobile terminal, the method comprising:
monitoring a downlink control channel shared by mobile terminals in one or more radio nets to detect whether the network is retransmitting dispatch traffic targeted to the radio net of the first mobile terminal; and
receiving and processing the retransmitted dispatch traffic if it is targeted to the radio net of the first mobile terminal.

53. The method of claim 52, further comprising monitoring the downlink control channel for an indication of a new downlink control channel assignment and switching to monitoring the new downlink control channel if the retransmitted dispatch traffic is not targeted to the radio net of the first mobile terminal.

54. The method of claim 52, wherein monitoring a downlink control channel shared by mobile terminals in one or more radio nets to detect whether the network is retransmitting dispatch traffic targeted to the radio net of the first mobile terminal comprises receiving retransmitted dispatch traffic on the downlink control channel and recovering an indication of radio net identity from the retransmitted dispatch traffic.

55. The method of claim 54, further comprising, after an end of the retransmitted dispatch traffic, receiving an indication of a new downlink control channel assignment on the downlink control channel, and switching to monitoring the new downlink control channel.

56. The method of claim 54, wherein receiving and processing the retransmitted dispatch traffic if it is targeted to the radio net of the first mobile terminal comprises recovering transmitted data from received retransmitted dispatch traffic if the recovered radio net identity matches the radio net identity of the first mobile terminal.

57. The method of claim 52, wherein monitoring a downlink control channel shared by mobile terminals in one or more radio nets to detect whether the network is retransmitting dispatch traffic targeted to the radio net of the first mobile terminal comprises monitoring an allocated sub-channel of a multiplexed downlink control channel for an indication that the network is or will be retransmitting dispatch traffic targeted to the radio net of the first mobile terminal.

58. The method of claim 57, wherein the indication that the network is or will be retransmitting dispatch traffic targeted to the radio net of the first mobile terminal identifies a downlink traffic channel, and wherein receiving and processing the retransmitted dispatch traffic if it is targeted to the radio net of the first mobile terminal comprises receiving the retransmitted dispatch traffic on the identified downlink traffic channel.

59. The method of claim 52, further comprising receiving an indication of mobile terminal identity for an originating mobile terminal that originated the retransmitted dispatch traffic.

60. The method of claim 59, further comprising, if the retransmitted dispatch traffic is targeted to the radio net of the first mobile terminal, using the received mobile terminal identity in secure decoding of the retransmitted dispatch traffic.

61. The method of claim 52, further comprising transmitting dispatch traffic from the first mobile terminal on an uplink control channel to which the first mobile terminal is assigned responsive to push-to-talk events at the first mobile terminal, wherein the uplink control channel is shared by mobile terminals in the one or more radio nets.

62. The method of claim 61, further comprising monitoring the downlink control channel for an indication that the first mobile has seized the uplink control channel.

63. A mobile terminal for use in a push-to-talk communication network with reduced dispatching delays, the mobile terminal comprising:
a receiver circuit to receive retransmitted dispatch traffic on a downlink control channel shared by mobile terminals in one or more radio nets; and
a processor circuit to monitor the downlink control channel to detect whether the network is retransmitting dispatch traffic targeted to the radio net of the mobile terminal, and to process the retransmitted dispatch traffic if it is targeted to the radio net of the mobile terminal.

64. The mobile terminal of claim 63, wherein the processor circuit is configured to monitor the downlink control channel for an indication of a new downlink control channel assignment and to switch the receiver circuit to begin monitoring the new downlink control channel if the retransmitted dispatch traffic is not targeted to the radio net of the mobile terminal.

65. The mobile terminal of claim 63, wherein the processor circuit is configured to monitor the downlink control channel to detect whether the network is retransmitting dispatch traffic targeted to the radio net of the mobile terminal by receiving retransmitted dispatch traffic on the downlink control channel and recovering an indication of radio net identity from the retransmitted dispatch traffic.

66. The mobile terminal of claim 65, wherein, if the retransmitted dispatch traffic was targeted to the radio net of the mobile terminal, the processor circuit is configured to switch the receiver circuit to begin monitoring a new downlink control channel responsive to detecting an indication of a new downlink control channel assignment transmitted on the downlink control channel after an end of the retransmitted dispatch traffic.

67. The mobile terminal of claim 63, wherein the processor circuit is configured to process the retransmitted dispatch traffic if it is targeted to the radio net of the mobile terminal by recovering a radio net identity from the retransmitted dispatch traffic and selectively recovering transmitted data from the retransmitted dispatch traffic if the radio net identity matches that of the mobile terminal.

68. The mobile terminal of claim 63, wherein the downlink control channel shared by mobile terminals in one or more radio nets comprises a multiplexed downlink control channel, and wherein the processor circuit is configured to detect whether the network is retransmitting dispatch traffic targeted to the radio net of the mobile terminal by monitoring an allocated sub-channel of the multiplexed downlink control channel for an indication that the network is or will be retransmitting dispatch traffic targeted to the radio net of the mobile terminal.

69. The mobile terminal of claim 68, wherein the indication that the network is or will be retransmitting dispatch traffic targeted to the radio net of the mobile terminal identifies a downlink traffic channel, and wherein the processor circuit is configured to configure the receiver circuit to receive the retransmitted dispatch traffic on the identified downlink traffic channel.

70. The mobile terminal of claim 63, wherein the mobile terminal receives an indication of mobile terminal identity for an originating mobile terminal that originated the retransmitted dispatch traffic.

71. The mobile terminal of claim 70, wherein the processor circuit is configured to use the mobile terminal identity in secure decoding of the retransmitted dispatch traffic if the retransmitted dispatch traffic is targeted to the radio net of the mobile terminal.

72. The mobile terminal of claim 63, wherein the processor circuit is configured to transmit dispatch traffic via the receiver circuit on an uplink control channel to which the mobile terminal is assigned responsive to push-to-talk events at the mobile terminal.

73. The mobile terminal of claim 72, wherein the processor circuit is configured to monitor the downlink control channel for an indication that the mobile terminal has seized the uplink control channel.

74. A method for reducing latency in a trunked dispatch communication system comprising:
allocating a plurality of radio nets to an uplink and downlink control channel; and
allowing a given one of the radio nets to retain the uplink and downlink control channel for traffic transmission responsive to the given radio net becoming active while reallocating remaining ones of the radio nets to a new uplink and downlink control channel, thereby associating any reallocation delays to inactive radio nets rather than to active radio nets.

75. A method of operating a relay station to provide push-to-talk communications for a plurality of radio nets, each radio net comprising a plurality of transmitter-receiver terminals, the method comprising:
allocating an initial uplink and downlink channel to be shared by a group of the radio nets;
detecting a transmission of traffic from one of the terminals and determining an identity of the terminal;
decoding, re-encoding, and transmitting the traffic on the downlink channel; and
transmitting an indication of the identity of the terminal and the radio net to which the terminal belongs and transmitting the indication on periodically on the downlink channel along with an indication of a new shared uplink and downlink channel to which other radio nets in the group should move.

76. A transmitter-receiver terminal for use in a trunked dispatch communication system comprising:
a receiver to decode a relay station signal and to determine whether, in a first case, the relay station signal is indicative of an idle control channel, or, in a second case, is indicative of an active traffic channel carrying traffic intended for the terminal, or, in a third case, is indicative of an active traffic channel carrying traffic not intended for the terminal; and
a transmitter to transmit a terminal signal to a relay station using a first signal format in the first case, using a second signal format in the second case, and to terminate transmission in the third case.

77. The terminal of claim 76, wherein the receiver is configured further to determine whether, in a fourth case, the relay station signal is indicative of an active traffic channel carrying an end-of-message indication intended for the terminal.

78. The terminal of claim 77, wherein the transmitter is configured to transmit the terminal signal using a third signal format that indicates an end-of-message until the receiver of the terminal detects the fourth case.

79. The terminal of claim 76, wherein the terminal is configured to initiate a transmission of traffic to a relay station and, upon completing transmission of the traffic, is configured to transmit an end-of-message indicator to the relay station until the terminal detects a corresponding end-of-message indicator in the relay station signal being transmitted from the relay station.
